(19) United States
(12) Patent Application Publication
(10) Pub. No.: US 2024/0407374 A1
(43) Pub. Date: Dec. 12, 2024

(54) IMPROVED INHIBITORY DNA COMPOSITIONS AND USE THEREOF, IN PARTICULAR INTEGRATED WITH METABOLIC TREATMENT TO ENHANCE INHIBITORY EFFECTS

(71) Applicant: NO SELF S.R.L., NAPOLI (NA) (IT)

(72) Inventor: Stefano MAZZOLENI, NAPOLI (NA) (IT)

(21) Appl. No.: 18/294,512

(22) PCT Filed: Aug. 4, 2022
(86) PCT No.: PCT/IT2022/050221

§ 371 Date: Feb. 1, 2024

(30) Foreign Application Priority Data
Aug. 6, 2021 (IT) 102021000021392

(51) Int. Cl. A01N 63/60; A01N 63/40; A01P 1/00

(52) U.S. Cl. CPC A01N 63/60; A01N 63/40; A01P 1/00

(57) ABSTRACT

Compositions for inhibiting a target species or a target cancer cell of a species include DNA sequences secreted by the cells of a species identical or phylogenetically similar to the target species or by a cancer cell affected by the same cancer as the target cancer cell of a species. The compositions can be used in any field where the inhibition of a species or of a cancer cell is beneficial including in human and/or veterinary medicine or in agriculture for the control of pest or diseases.

The present invention concerns improved inhibitory DNA compositions and use thereof, in particular integrated with metabolic treatment to enhance inhibitory effects.

In particular, the present invention concerns compositions suitable for inhibiting a target species or a target cancer cell of a species, methods and uses of the compositions, wherein the compositions comprise DNA sequences secreted by the cells of a species identical or phylogenetically similar to the target species or by a cancer cell affected by the same cancer as the target cancer cell of a species. The compositions according to the present invention can be advantageously used in any field where the inhibition of a species or of a cancer cell is beneficial, for example in human and/or veterinary medicine or in agriculture for the control of pest or diseases.

It is known that the control of harmful species and cell proliferation has been faced by different approaches, including the use of antimicrobials, phages and chemotherapy compounds. These treatments present collateral damaging effects such as general toxicity and resistance in both microbial strains and cancer cells.

In both fields of the control of harmful species and the cancer therapy, a major goal is the reduction of the effective dosages of the different active agent or therapeutic compounds to achieve the desired control with limitation of the side effects such as the toxicity effects.

Regarding the control of harmful species, recently, it has been found that fragmented extracellular DNA produces an inhibitory effect on a species from which the DNA is derived and on a phylogenetically similar species having a similar genome (Mazzoleni et al. 2015; WO2014/020624). In other words, the results have shown that the inhibitory effect of self-DNA fragments is species-specific.

In particular, self-inhibitory DNA fragments are obtained by random fragmentation of isolated total DNA from the species to be inhibited (or from a phylogenetically similar species) or by random DNA fragment synthesis starting from total DNA of the species (or from a phylogenetically similar species).

The inhibitory effect of self-inhibitory DNA fragments has been shown in different living organisms ranging over different kingdoms, including plants, algae, bacteria, fungi, protozoa, insects.

According to this knowledge, every harmful species can be advantageously controlled by their own DNA. In fact, several experiments demonstrated that every tested species was negatively affected by increasing concentrations of self-DNA while it was unaffected by heterologous DNA. The observed inhibition on a species can be produced by random fragments of its own genomic DNA with a dosage dependent inhibition. Significant effects have been reported for different species at concentrations of DNA in either the growing substrate or the food of the target species usually above 100 ppm.

More recently, this discovery was confirmed by other authors reporting significant effects at similar self-DNA concentration levels with increasing inhibition of root growth and development on bean plants at concentrations of 50, 100, 150 and 200 ppm (Duran-Flores and Heil, 2018).

It is also known that fragmented self-DNA can be delivered by host species different from the target species, as described in the patent application WO2020167128.

In the light of the above, it is therefore apparent the need to provide new products and methods for the control of harmful species and cell proliferation, which overcome the disadvantages of known products and methods and/or present enhanced effectiveness.

The existence of free circulating DNA in the environment is an established knowledge (see review Nagler, 2018). The origin of such environmental DNA can be related to either cell lysis and consequent release of genomic contents or secretion active processes by living cells. Secretion of nucleic acids by living cells has been widely reported in the scientific literature (Blesa and Berenguer, 2015; Draghi and Turner, 2006; Kalluri and LeBleu, 2016; Thierry et al., 2016). The secretion rate has been related to proliferation rate of the secreting tissues (Blesa and Berenguer, 2015). The production of exosomes containing DNA fragments has also been reported to increase in senescent cells (Lehmann et al., 2008).

Moreover, there is a large body of evidence in the scientific literature on free circulating DNA in blood in relation to cancer. The presence of small amounts of DNA from tumour cells in cell free DNA (cfDNA) circulating in the plasma or serum of cancer patients was first demonstrated more than 30 years ago (van der Vaart and Pretorius, 2007).

Although the mechanisms of secretion and release of DNA from living cells remain to be elucidated, several hypotheses have been made about possible functions:
cell-cell signalling (Segev et al., 2015; Monticolo et al., 2020);
horizontal gene transfer (Blesa and Berenguer, 2015; Draghi and Turner, 2006);
oncogenic transformation (Kalluri and LeBleu, 2016).

Recently, Takahashi et al. (Takahashi et al. 2017) have shown that the inhibition of exosome secretion in human cells resulted in an accumulation of nuclear DNA in the cytoplasm provoking an innate immune response and ROS production. The authors concluded that exosome secretion can function as a defense mechanism from harmful cytoplasmic DNA accumulation.

According to the present invention, it has been now found that self-DNA secreted by the cells of a species (or by the cells of a phylogenetically similar species) shows enhanced inhibitory effects on said species in comparison to total self-DNA of the same species (or of a phylogenetically similar species).

It is known that a cell can release extracellular self-DNA both by secretion and by disruption or lysis of the cell.

The term “total self-DNA” is herewith intended as the whole genome DNA comprised in a cell of a species that can be extracted from the cell. Instead, “secreted self-DNA” or “secreted DNA” is DNA actively secreted by a living cell, therefore, it is a subset of the total self-DNA. In particular, secreted self-DNA consists of a mixture of DNA sequences with different sequences. Extracellular self-DNA is a general term referring to DNA recovered from the growth environment that may correspond to DNA released by disruption or lysis of dead cells (genomic DNA), together with secreted self-DNA, so that the DNA recovered corresponds to “total self-DNA”. Differently, extracellular self-DNA recovered from media containing only living cells will be corresponding to only “secreted self-DNA” or “secreted DNA” as defined above.

According to the present invention, it has been found that the known inhibition of a species by total self-DNA, genomic self-DNA or by extracellular self-DNA, can be significantly enhanced by using only secreted self-DNA.

The experimental results show that secreted self-DNA can exert a more specific inhibition than total self-DNA.

More particularly, secreted self-DNA derived from a species to be inhibited (or from a phylogenetically similar species) or by synthesis shows enhanced inhibitory effects in comparison to self-DNA fragments obtained by random fragmentation of isolated total self-DNA from the species to be inhibited (or from a phylogenetically similar species) or by random DNA fragment synthesis starting from total DNA of the species (or from a phylogenetically similar species).

The examples further below show that secreted self-DNA is able to inhibit a species at significant lower dosage than the total self-DNA. No inhibition takes place when cells are treated with secreted DNA produced by cells of a different species. These results have been obtained on bacteria, yeast and human cells.

In addition, according to the present invention, it has been surprisingly found that, in a species, the inhibitory effects of secreted self-DNA are specific against a cell expressing the same functions (i.e., same genetic pathways/metabolism) as the cell from which self-DNA is secreted.

The examples show that the secreted DNA of cells grown under different physiological conditions is different. DNA fragments extracted from the supernatants of yeast cells grown under either respiratory or fermentative metabolism have been sequenced. The results revealed that different subsets of the total genome DNA were secreted.

As mentioned above, the inhibitory effect of secreted self-DNA is more than species specific because it is higher for cells expressing the same functions (i.e., genetic pathways/metabolism) of the cells whose secreted DNA has been obtained.

In fact, according to the examples, fermentative yeast cells show higher levels of inhibition when they are exposed to the secreted DNA extracted from yeast cells expressing a similar fermentative metabolism, while lower inhibitory effect is observed if the same cells are treated with secreted DNA extracted from yeast cells expressing only a respiratory metabolism. These results have been obtained with bacteria, yeast and human cells.

This finding can be advantageously applied to tumoral cells of a species for which the results have been particularly surprising.

According to the present invention, the inhibitory effect of DNA extracted from tumoral cell lines against the same cell line (ES-2) and versus a healthy human cell line (HaCat) was firstly tested. Then, the inhibitory effect of the growth medium containing only the secreted DNA of the tumoral cell line, without DNA released by disruption or lysis of the cells, was tested on the same cells and on the healthy cell line.

The results show that the inhibitory effect of secreted self-DNA on tumoral cells is higher than the inhibitory effect of extracted total self-DNA.

No inhibitory effect is observed by using extracted or secreted self-DNA from a different cell line.

Therefore, according to the present invention, it has been found that secreted self-DNA can be advantageously used in order to inhibit or control a target organism of a species or a target cancer cell population of an organism of a species. The inhibition or control of a target organism of a species is obtained by using self-DNA secreted by the cells of the same species (or of phylogenetically similar species) of the organism. The inhibition or control of a target cancer cell population of an organism of a species is obtained by using self-DNA secreted by a cancer cell suffering from the same cancer as the target cancer cell of a species that in its turn is identical to the species of the target cell. Self-DNA secreted by the cancer cell can be obtained from the same subject to be treated or from a different subject of the same species, for example from a cancer cell line.

In addition, according to the present invention, it has been found that the inhibitory effects of secreted self-DNA on a target species or on a target cancer cell population of a species are improved by the combination with a different treatment, such as a treatment inhibiting the target species or the target cancer cell or a metabolic treatment, showing a reinforced specificity of the inhibition effect. This has been demonstrated in the following Proofs of Concept (POCs) of combined treatments:
Phage/self-DNA treatment on resistant bacterial species;
Glucose pulse/self-DNA treatment on both yeast and tumoral cells;
Chemotherapy/self-DNA treatment on cisplatin-resistant tumoral cells.

The experimental results show that the combination of self-DNA with a phage treatment in bacteria is able to enhance the inhibitory effects in comparison to the use of phages alone.

In addition, it has been found that the combination of exposure to secrete self-DNA and to high glucose levels induce specific cell mortality in both yeast and tumoral cells.

In particular, yeast cells grown in bioreactor start to die when inhibited by the accumulation of secreted DNA and are, at the same time, exposed to high sugar concentrations. Similar results have been also obtained with tumoral cell lines. In fact, the combined exposure of tumoral cells to their own secreted DNA and glucose pulses (i.e., sudden administration of concentrated glucose to the culture medium) was shown to induce an apoptotic effect.

This latter result bears potential therapeutic relevance considering the high specificity of the inhibitory effect of the secreted DNA and the inability of cancer cells to modulate glucose uptake rate (differently from healthy cells). Therefore, a therapy of cancer comprising the exposure of cancer cells to DNA secreted by the cancer cells and to high concentrations of sugar can provide an effective means to specifically target cancer cells in vivo.

The effectiveness of the combination of DNA secreted by the cancer cells and high concentrations of sugar is also confirmed by model simulations. The model simulations show the effect of the combined exposure to growth inhibitors and different levels of insulin on tumoral and healthy cell lines. A cancer treatment integrated with secreted self-DNA followed by glucose boost resulted in total cancer remission due to induction of Sugar Induced Cell Death (SICD) in tumoral cells by their specific growth inhibition.

The sugar-induced cell death (SICD) is a phenomenon observed in yeast cells, where sudden death of stationary phase yeast populations is reported after exposure to glucose (Granot et al., 2003). Recently, de Alteriis et al. (2018) provided a putative mechanism for such phenomenon highlighting the metabolic similarities between yeast and cancer cells related to the unbalance of ATP intracellular levels associated to the dynamics of glucose uptake and glycolysis pathway. In relation to this, it is also relevant considering that most cancer cells present mutations that increase glucose uptake compared to healthy cells (Barron et al. 2016; DeBerardinis et al., 2008).

It is therefore specific object of the present invention a non-therapeutic method for inhibiting a target species, said method comprising or consisting of exposing said target species to DNA sequences secreted by the cells of a source species or to a composition comprising said DNA sequences, wherein said source species is selected from a species that is the same species as the target species or a species phylogenetically similar to the target species, with the proviso that said DNA sequences or composition do not comprise any DNA released by dead cells (genomic DNA) of the source species and do not comprise any secretome obtained by said cells of the source species.

For example, the DNA sequences are obtainable from a medium of a culture of said cells comprising only living cells without the presence of dead cells.

In addition, the DNA sequences of the invention are not engineered into a plasmid or vector for protein expression.

According to the present invention, the term “species” refers to an abstract concept and a species as such cannot be inhibited. Reference to a species should thus be construed as meaning individuals or organisms of the species, such as a plurality of individuals or organisms of the species, i.e., a population.

The term “target species” refers to infesting, pathogenic, parasitic species. The term comprises also species that are grown with a specific metabolism, for example aerobic or anaerobic metabolism, or grown in the presence of a specific carbon source or in the presence of specific nutrients, such as for example nitrogen, phosphorus.

A list of target species is described further below.

The term “source species” refers to a species from which the secreted DNA sequences are derived. This means that the secreted DNA sequences can be actually secreted by the cells of said source species or can be synthetized with the same sequence as those actually secreted by the cells of said species.

As mentioned above the source species can be selected from a species that is the same species as the target species or a species phylogenetically similar to the target species.

The term source species comprises also species that are grown with the same specific metabolism as the target species, for example aerobic or anaerobic metabolism, or grown in the presence of the same specific carbon source as the target species or in the presence of the same specific nutrients as the target species, such as for example nitrogen, phosphorus.

Therefore, secreted DNA sequences according to the present invention are not only species specific, but inside the same species the secreted DNA sequences are able to inhibit more effectively the target species (in comparison to total self-DNA or DNA sequences secreted by the cells of the species grown with a different metabolism) when said DNA sequences are secreted by the cells of the source species that is grown with the same specific metabolism as the target species.

The term “phylogenetically similar species” refers to a species having a similar genome. The skilled person will understand that species that are phylogenetically closely related have a more similar genome than species that are phylogenetically distant. Phylogenetically similar thus means having a close phylogenetically relation. Phylogenetic similarity may thus be determined based on known phylogenetic relations. Thus, according to certain preferred embodiments phylogenetically similar species are species within the same taxonomic order. Within a certain order, phylogenetically similar species are preferably from a same monophyletic group (clade), such as from a same family, a same subfamily, a same tribe, a same subtribe, a same genus. It is most preferred that phylogenetically similar species are from the same taxonomic family, such as a same subfamily, a same tribe, a same subtribe, a same genus. In addition, techniques for determining genome similarity (or relatedness) are readily available. Genome similarity may for example be determined by determining the renaturation/reassociation kinetics of single stranded DNA (ssDNA) fragments of the genomes from both species. Alternatively, or in addition, denaturation (melting) of double stranded DNA (dsDNA) fragments renatured from mixtures of ssDNA fragments of the genomes from both species may be investigated. The latter technique allows for the definition of the melting temperature Tm, i.e., the temperature at which half of the DNA strands are in the ssDNA state and of the related T50H. Approaches involving renaturation/denaturation kinetics and assessment of melting profiles were introduced in the early 70's (see de Ley et al. Eur J Biochem. 1970 January; 12(1):133-42) for determining the relatedness of bacteria, but these approaches involving melting temperature profile analyses have also been used for determining the relatedness of eukaryotic species (see for example Sibley and Ahlquist, J Mol Evol (1984) 20:2-15).

As is further known, since the publication of WO2014/020624, phylogenetic similarity of species can be determined on the basis whether inhibitory DNA fragments from one species are also inhibitory for another species. Therefore, a phylogenetically similar species is thus a species whereof DNA obtained by random fragmentation of extracted total DNA or by random fragment synthesis starting from total DNA is inhibiting for the target species. It will be clear for the skilled person that based on this functional definition phylogenetic can be determined with tests similar to those presented in WO2014/020624 and in the experiments attached herewith. Within the same taxonomic order, a source species will also be phylogenetically similar to a target species, because DNA obtained from the source species by random fragmentation of extracted total DNA or by random fragment synthesis starting from total DNA is inhibiting for the target species.

Analogously, a phylogenetically similar species is thus a species whereof secreted DNA sequences are inhibiting for the target species.

The term “DNA sequences secreted by the cells of a source species” refers to a mixture of secreted DNA sequences, that can be natural or synthetic. The mixture of secreted DNA sequences is a specific subset of total self DNA, said mixture not comprising genomic DNA sequences obtained by extraction from cells or by disruption or lysis of cells of the source species.

As mentioned above, the term “DNA sequences” refers to a mixture of different secreted DNA sequences, whereas it does not comprise a single DNA sequence.

With the term “secreted DNA sequences” is intended DNA sequences actively secreted by living cells of the source species or synthetic DNA sequences with the same sequence as those actively secreted by living cells or tissues of the source species. The term does not refer to generic extracellular DNA that can be recovered from growth media that may include fragments of genomic DNA deriving from cell death/lysis in addition to secreted DNA. According to the present invention, when secreted DNA is recovered from growth media, the recovering is carried out from growth media of cell cultures containing only living cells, therefore from growth media containing only secreted-DNA.

As the skilled person will understand the term “inhibition” in the context of inhibition of a target species refers to interference with, slowing down or even stopping development of target species individuals and/or the population of the target species. It may be expected that the inhibiting effect of inhibitory secreted DNA sequences (secreted self-DNA) work via interfering with the physiology of the target species at the cellular level. Secreted self-DNA should be understood to mean secreted DNA of a species or of a phylogenetically similar species.

The term “exposing” a target species means that secreted DNA sequences are administered to a target species by any suitable means, such as surface contacting, cytotropic administration, systemic administration by means of, for example, injection, ingestion or inhalation, or adsorption. Secreted DNA sequences can be used in a composition that can be formulated in a form, for dry or liquid treatments, selected in the group consisting of dispersion, for example in form of aerosol, suspension, wettable or soluble powders, emulsions in water or other solvents, dispersible granules, suspensions of microcapsules, emulsifiable concentrates, fluid pastes, macro emulsions, oil dispersions, baits. Solvent systems comprising water or deep eutectic solvent (DES) systems such as natural deep eutectic solvent (NADES) systems may be used.

Determination of the concentration ranges wherein secreted DNA sequences of the invention are inhibitory for the target species is within the ambit of the knowledge of the skilled person. The skilled person will understand that the required concentration may depend on factors such as the potency of the DNA in the composition to inhibit the target species or the target cell, the level of inhibition desired, whether or not an additional biocide is applied and/or the application route to the target species. For many applications, suitable concentrations may be in the range of 1-1500 ppm, such as 2-1300 ppm, 2-1000 ppm, 5-1000 ppm, 10-1000 ppm, 50-1000 ppm, 100-1000 ppm, 200-1000 ppm, 500-1000 ppm. For other applications higher concentrations may be desire.)

According to an embodiment of the non-therapeutic method of the present invention, said DNA sequences secreted by the cells of a source species can be delivered by a carrier. Said carrier can be a host species differing from the source species, for example a species selected from a microbial species, such as a bacterial species, or a species from the Ascomycota, or a species from the Archaea, or a microphyte, a multicellular organism, such as a multicellular plant, or a helminth species, a soil microorganism, a GRAS status microorganism, a microbial biocontrol agent.

A host species in the context of the present invention in general is a species differing from the source species, preferably a phylogenetically dissimilar species, having incorporated intracellularly source species DNA sequences. Phylogenetically dissimilar (distant) species according to certain embodiments are species from different taxonomic orders, such as from different classes, different phyla, different kingdoms, or different domains. According to certain embodiments phylogenetically dissimilar species are species from different families, such from different orders, different classes, different phyla, different kingdoms, or different domains. Host species may be selected from any species capable of taking up and replicating foreign DNA of the source species. For example, the host species can be Arthrospira platensis that can be used in dried or freeze-dried form or in aqueous solution. For example, it is used in agriculture together with irrigation.

According to an embodiment of the non-therapeutic method of the present invention, when the target species is a bacterium, said composition comprising the DNA sequences secreted by the cells of a source species can further comprise a phage effective against said bacterium. For example, according to the present invention, the bacterium can be a Klebsiella, such as Klebsiella pneumoniae.

The present invention concerns also DNA sequences or a composition comprising said DNA sequences for use in the therapeutic treatment of a disease or condition of an animal organism or a human organism, said disease or condition being caused by a pathogenic, infesting or parasitic species or being a cancer disease,
wherein said DNA sequences are the active principle inhibiting said pathogenic, infesting or parasitic species, the target species, or a cancer cell of said cancer disease, the target cell,
said DNA sequences being DNA sequences secreted by:
the cells of a source species selected from a species that is the same species as the target species or a species phylogenetically similar to the target species, when the disease or condition is caused by a pathogenic, infesting or parasitic species; or
a source cancer cell of the same cancer disease to be treated, said source cancer cell being selected from
the target cell of the same animal organism or human organism to be treated, or
a cancer cell of an animal or human organism different from the animal or human organism to be treated;
with the proviso that said DNA sequences or composition do not comprise any DNA released by a dead cell (genomic DNA) of the source species or by a dead source cancer cell and do not comprise any secretome of the cell of the source species or of the source cancer cell.

For example, the DNA sequences are obtainable from a medium of a culture of said cells comprising only living cells without the presence of dead cells.

In addition, the DNA sequences of the invention are not engineered into a plasmid or vector for protein expression.

According to the present invention the term “different animal” is intended an animal of the same species. Therefore, the source cancer cell can be for example a cancer cell of a patient or a cancer cell of a cell line grown in controlled conditions. In other words, according to the present invention, secreted DNA to be used in cancer therapy can be DNA secreted by cell cultures from biopsies of cancerous tissues of the patient or DNA secreted by cultures of tumors of the same type present in tissue banks. The cancer to be treated can be for example Lung and bronchial cancer, Colon and rectal cancer, Breast cancer, Pancreatic cancer, Prostate cancer, Leukemia, Non-Hodgkin lymphoma, Liver and intrahepatic bile duct cancer, Ovarian cancer, Esophageal cancer, Brain cancer including glioms, Carcinomes and Melanomes.

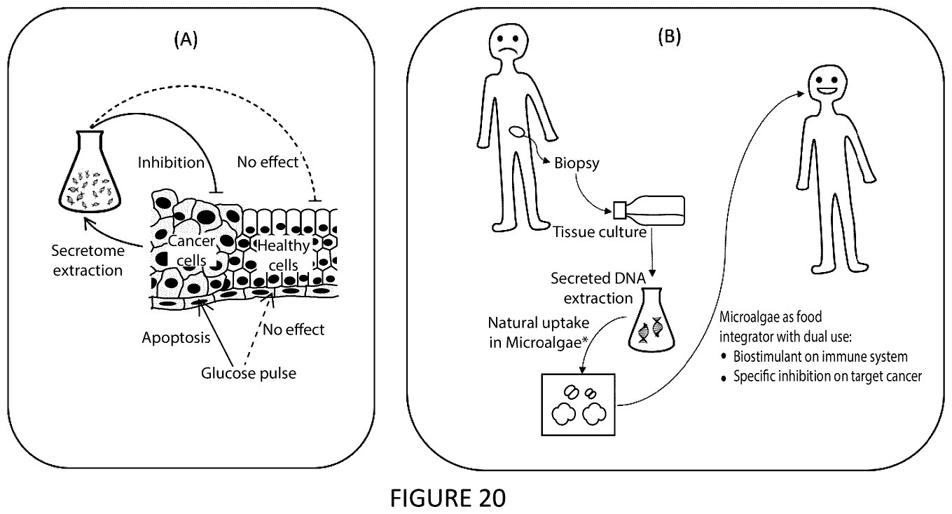

According to an embodiment of the invention referred to DNA sequences or composition as defined above for use as defined above, said DNA sequences can be delivered by a carrier. Said carrier can be a host species differing from the source species or from an animal or human cell, for example the host species is a species selected from a microbial species, such as a bacterial species, or a species from the Ascomycota, or a species from the Archaea, or a microphyte, a multicellular organism, such as a multicellular plant, or a helminth species, a soil microorganism, a GRAS status microorganism, a microbial biocontrol agent. In particular, the host species can be Arthrospira platensis, preferably when the DNA sequences are secreted by a source cancer cell. For example, the natural uptake of DNA secreted by the cells of the source species or by the source cancer cell can be induced by incubating the host species, such as A. platensis, a species belonging to cyanobacteria, with the DNA sequences secreted by the cells of said source species or by the source cancer cell. A scheme of the treatment is represented in FIG. 20B. Arthrospira platensis comprising the secreted DNA can be used according to the present invention in dried or freeze-dried form, such as pills, in aqueous solution or in alive form.

According to the present invention, the composition as defined above, for use as define above, can further comprise a further active principle (or a drug) suitable for treating the disease or condition, such as an anticancer active principle, for example cisplatin.

According to an embodiment, when the target species is a bacterium, the composition as defined above, for use according to the above, can further comprises a phage effective against said bacterium.

The present invention concerns also a combination of DNA sequences with one or more other active principles suitable for treating a disease or condition, said one or more other active principles being different from said DNA sequences, said combination being for the separate or sequential use in the therapeutic treatment of a disease or condition of an animal or a human organism, said disease or condition being caused by a pathogenic, infesting or parasitic species or being a cancer disease,
wherein said DNA sequences are the active principle inhibiting said pathogenic, infesting or parasitic species, the target species, or a cancer cell of said cancer disease, the target cell,
said DNA sequences being DNA sequences secreted by:
the cells of a source species selected from a species that is the same species as the target species or a species phylogenetically similar to the target species, when the disease or condition is caused by a pathogenic, infesting or parasitic species; or
a source cancer cell of the same cancer disease to be treated, said source cancel cell being selected from
the target cell of the same animal organism or human organism to be treated, or
a cancer cell of an animal or human organism different from the animal or human organism to be treated,
with the proviso that said DNA sequences or composition do not comprise any DNA released by a dead cell (genomic DNA) of the source species or by a dead source cancer cell and do not comprise any secretome of the cell of the source species or of the source cancer cell.

For example, the DNA sequences are obtainable from a medium of a culture of said cells comprising only living cells without the presence of dead cells.

In addition, the DNA sequences of the invention are not engineered into a plasmid or vector for protein expression. As mentioned above, the term “different animal” is intended an animal of the same species. Therefore, the source cancer cell can be for example a cancer cell of a patient or a cancer cell of a cell line grown in controlled conditions.

According to the present invention, the term “separate use” is understood as meaning the administration, at the same time, of the two compounds of the combination according to the invention in distinct pharmaceutical forms. The term “sequential use” is understood as meaning the successive administration of the two compounds of the combination according to the invention, each in a distinct pharmaceutical form.

According to an embodiment of the combination of the present invention, for use as defined above, said DNA sequences can be delivered by a carrier. Said carrier can be a host species differing from the source species or from an animal or human cell, for example the host species is a species selected from a microbial species, such as a bacterial species, or a species from the Ascomycota, or a species from the Archaea, or a microphyte, a multicellular organism, such as a multicellular plant, or a helminth species, a soil microorganism, a GRAS status microorganism, a microbial biocontrol agent. For example, the host species can be Arthrospira platensis, preferably when the DNA sequences are secreted by a source cancer cell. As mentioned above, for example, the natural uptake of DNA secreted by the cells of the source species or by the source cancer cell can be induced by incubating the host species, such as A. platensis, a species belonging to cyanobacteria, with the DNA sequences secreted by the cells of said source species or by the source cancer cell.

According to a further embodiment of the present invention, said one or more other active principles can be selected from an anticancer active principle, glucose and/or insulin. In particular, after or simultaneously the administration of the secreted DNA sequences, insulin and glucose can be sequentially administered at least one time in order to induce at least one hypoglycemic peak followed by at least one hyperglycemic peak. Such glucose treatment will be executed through the administration of fine-tuned insulin treatments followed by a phleboclysis of glucose in physiological solution. Such intravenous drip of sugar, inducing a controlled and limited in time hyperglycemic condition after the lowering of glucose content due to the pre-treatment by insulin. The treatment is conceived as a “starving” phase followed by a fast uptake of glucose from the bloodstream. At the same time, due to the differential growth inhibition induced by the secreted DNA, cancer cells shall be induced to enter in apoptosis.

According to an embodiment of the combination of the present invention, for use according to the above, when the target species is a bacterium, said one or more other active principles can be a phage effective against said bacterium.

The present invention concerns also a composition for inhibiting a target species or for inhibiting a target cancer cell of an animal organism or human organism to be treated (against cancer), said composition comprising or consisting of DNA sequences secreted by the cells of a source species or by a source cancer cell, wherein
said source species is selected from a species that is the same species as the target species or a species phylogenetically similar to the target species,
said source cancer cell being selected from the target cell of the same animal organism or human organism to be treated, or a cancer cell of an animal or human organism different from the animal or human organism to be treated, and
said DNA sequences are delivered by a carrier,
with the proviso that said DNA sequences or composition do not comprise any DNA released by a dead cell (genomic DNA) of the source species or by a dead source cancer cell and do not comprise any secretome of the cell of the source species or of the source cancer cell.

For example, the DNA sequences are obtainable from a medium of a culture of said cells comprising only living cells without the presence of dead cells.

In addition, the DNA sequences of the invention are not engineered into a plasmid or vector for protein expression.

Said carrier can be a host species differing from the source species, for example a species selected from a microbial species, such as a bacterial species, or a species from the Ascomycota, or a species from the Archaea, or a microphyte, a multicellular organism, such as a multicellular plant, or a helminth species, a soil microorganism, a GRAS status microorganism, a microbial biocontrol agent. For example, the host species can be Arthrospira platensis, preferably when the DNA sequences are secreted by a source cancer cell.

According to the present invention, when the target species is a bacterium, said composition further comprises a phage effective against said bacterium.

The present invention further comprises a composition for inhibiting a bacterium, the target species, said composition comprising or consisting of DNA sequences secreted by the cells of a source species and a phage effective against said bacterium, wherein said source species is selected from the same bacterium as the target species or a bacterium phylogenetically similar to the target species.

For example, according to the present invention, the bacterium can be a Klebsiella, such as Klebsiella pneumoniae.

The compositions according to the present invention can be pharmaceutical compositions comprising excipients and/or adjuvants pharmaceutically acceptable.

On the basis of the above, according to the present invention, the target species may be both a unicellular organism and a multicellular organism. The target species may be a species selected from plants, fungi, insects, yeasts, bacteria, archaea, algae, nematodes, acari, and prostists, preferably a species which may cause health and/or economic and/or environmental damage. Such a target species may for example be a disease associated species, such as a pathogenic species a parasitic, species or a species serving as a disease vector, or may be an infesting species, or may be a species associated with deterioration of products, such as of food products and/or of cosmetic products and/or of pharmaceutical products and/or of other products comprising organic matter. Disease associated species may cause and/or facilitate the spreading of a diseases to an animal, in particular to a human and/or a livestock animal, or to a plant, in particular to a crop. An infesting species may be any species, such as an insect species, or a higher animal species, or plant species, whereof individuals are present in a place or site (the target area) in larger than desired numbers. Infesting species at least cause nuisance and may (potentially) cause damage or harm. An infesting species according to certain embodiments may thus be considered a pest. As the skilled person will understand, biological species may cause deterioration of products in many ways. Often the mere presence of individuals of a species are undesired, such as in food products, in particular when the species can produce off-flavours and/or toxins. In addition, conversion of organic matter present in a product may lead to a reduced product quality, such as by the product not conforming to product specifications and/or by a (partial) loss of product function. It will be clear for the skilled person that the terms “disease associated species”, “pathogenic species”, “parasitic species”, “species serving as a disease vector”, “infesting species” and “species associated with deterioration of products” are not mutually excluding and that there is a degree of overlap between two or more of these terms. The terms are merely used to identify domains where inhibition of a target species may be beneficial and where the present invention preferably is employed.

When the target species is selected as a pathogenic species, it may be selected from Acinetobacter baumannii, or Actinomyces israelii, or Actinomyces gerencseriae, or Propionibacterium propionicus, or Trypanosoma brucei, or Entamoeba histolytica, or Anaplasma species, or Angiostrongylus species, or Anisakis species, or Bacillus anthracis, or Arcanobacterium haemolyticum, or Ascaris lumbricoides, or Aspergillus species, or species of the Astroviridae family, or Babesia species, or Bacillus cereus, or Bacteroides species, or Balantidium coli, or Bartonella, or Baylisascaris species, or Piedraia hortae, or Blastocystis species, or Blastomyces dermatitidis, or Clostridium botulinum, or Brucella species, or Yersinia Pestis, or Burkholderia cepacia, or other Burkholderia species, or Mycobacterium ulcerans, or Caliciviridae family, or Campylobacter species, or Candida albicans, or other Candida species, or Capillaria philippinensis, or Capillaria aerophila, or Bartonella bacilliformis, or Bartonella henselae, or Group A Streptococcus spp., or Staphylococcus spp., or Trypanosoma cruzi, or Haemophilus ducreyi, or Chlamydia trachomatis, or Chlamydophila pneumoniae, or Vibrio cholerae, or Fonsecaea pedrosoi, or Batrachochytrium dendrabatidis, or Clonorchis sinensis, or Clostridium difficile, or Coccidioides immitis and Coccidioides posadasii, or Cryptococcus neoformans, or Cryptosporidium species, or Ancylostoma braziliense, or Cyclospora cayetanensis, or Taenia solium, or green algae, or Desmodesmus armatus, or Dientamoeba fragilis, or Corynebacterium diphtheriae, or Diphyllobothrium, or Dracunculus medinensis, or Echinococcus species, or Ehrlichia species, or Enterobius vermicularis, or Enterococcus species, or, or Rickettsia prowazekii, or Fasciola hepatica, or Fasciola gigantica, or Fasciolopsis buski, or PRNP, or Filarioidea superfamily, or Clostridium perfringens, or multiple, or Fusobacterium species, or Clostridium perfringens, or other Clostridium species, or Geotrichum candidum, or Giardia lamblia, or Burkholderia mallei, or Gnathostoma spinigerum, or Gnathostoma hispidum, or Neisseria gonorrhoeae, or Klebsiella granulomatis, or Streptococcus pyogenes, or Streptococcus agalactiae, or Haemophilus influenzae, or Helicobacter pylori, or Escherichia coli O157:H7, O111 and O104:H4, or species from the Bunyaviridae family, or Histoplasma capsulatum, or Ancylostoma duodenale and Necator americanus, or Ehrlichia ewingii, or Anaplasma phagocytophilum, or Ehrlichia chaffeensis, or Hymenolepis nana and Hymenolepis diminuta, or Orthomyxoviridae family, or Isospora belli, or Kingella kingae, or Legionella pneumophila, or Legionella pneumophila, or Leishmania species, or Mycobacterium leprae, or Mycobacterium lepromatosis, or Leptospira species, or Listeria monocytogenes, or Borrelia burgdorferi, or Borrelia garinii, or Borrelia afzelii, or Wuchereria bancrofti, or Brugia malayi, or Plasmodium species, or Burkholderia pseudomallei, or Neisseria meningitidis, or Metagonimus yokagawai, or Microsporidia phylum, or Rickettsia typhi, or Mycoplasma pneumoniae, or Mycoplasma genitalium, or Actinomycetoma spp., or Eumycetoma spp., or Chlamydia trachomatis and Neisseria gonorrhoeae, or Nocardia asteroids, or other Nocardia species, or Onchocerca volvulus, or Opisthorchis viverrini, or Opisthorchis felineus, or Paracoccidioides brasiliensis, or Paragonimus westermani, or other Paragonimus species, or Pasteurella species, or Pediculus humanus capitis, or Pediculus humanus corporis, or Pthirus pubis, or Bordetella pertussis, or Yersinia pestis, or Streptococcus pneumoniae, or Pneumocystis jirovecii, or Prevotella species, or Naegleria fowleri, or Chlamydophila psittaci, or Coxiella burnetii, or Borrelia hermsii, Borrelia recurrentis, oe other Borrelia species, or Rhinosporidium seeberi, or Rickettsia species, or Rickettsia akari, or Rickettsia rickettsii, or Salmonella species, or Sarcoptes scabiei, or Group A Streptococcus species, or Schistosoma species, or Shigella species, or Variola major, or Variola minor, or Sporothrix schenckii, or Staphylococcus species, or Strongyloides stercoralis, or Treponema pallidum, or Taenia species, or Clostridium tetani, or Trichophyton species, or Trichophyton tonsurans, or Epidermophyton floccosum, or Trichophyton rubrum, or Trichophyton mentagrophytes, or Trichophyton rubrum, or Hortaea werneckii, or Malassezia species, or Toxocara canis, or Toxocara cati, or Toxoplasma gondii, or Chlamydia trachomatis, or Trichinella spiralis, or Trichomonas vaginalis, or Trichuris trichiura, or Mycobacterium tuberculosis, or Francisella tularensis, or Salmonella enterica, or serovar typhi, or Rickettsia, or Ureaplasma urealyticum, or Coccidioides immitis, or Coccidioides posadasii, or Vibrio vulnificus, or Vibrio parahaemolyticus, or Trichosporon beigelii, or Yersinia pseudotuberculosis, or Yersinia enterocolitica, or Zeaspora fungus, or Mucorales, or Entomophthorales. It should be understood that inhibition of pathogenic target species need not be in or on an animal (including a human) body. Instead the inhibition may also be outside the context of an animal body. For example, for inhibiting the target species in a (in vitro) culture. Selection of pathogenic target species from topical pathogenic and/or topical target species is preferred, in particular topical pathogenic target species from the list presented directly above. The skilled person will understand that the term topical in the context of human and veterinary medicine means pertaining to a particular surface of the body, in particular the skin or mucous membranes (mucosa). Topical pathogenic target species should thus be considered to be associated with the skin and/or nails and/or with mucous membranes, including the mucous membranes of the eye, the mouth, the vagina, the urinary tract, the gastrointestinal tract, the airways, including the lungs. The term topical thus is not limited to the exterior surface of an animal body, but includes reference to internal surfaces, such as the lungs and gastrointestinal tract.

Topical pathogenic target species most preferably are skin pathogens and/or nail pathogens and/or are mucosal pathogens. Within the context of the present invention selection of pathogenic target species from archaea, bacteria, fungi (including yeasts) and protists is further preferred, in particular archaea, bacteria, fungi (including yeasts) and protists from the list presented directly above. When the target species is selected as a parasitic species, it may be selected from Acanthamoeba spp. or Balamuthia mandrillaris or Babesia B. divergens or B. bigemina or B. equi or B. microfti or B. duncani or Balantidium coli or Blastocystis spp. or Cryptosporidium spp. or Cyclospora cayetanensis or Dientamoeba fragilis or Entamoeba histolytica or Giardia lamblia or Isospora belli or Leishmania spp. or Naegleria fowleri or Plasmodium falciparum or Plasmodium vivax or Plasmodium ovale curtisi or Plasmodium ovale Wallikeri or Plasmodium malariae or Plasmodium knowlesi or Rhinosporidium seeberi or Sarcocystis or bovihominis, Sarcocystis or suihominis or Toxoplasma gondii or Trichomonas vaginalis or Trypanosoma brucei or Trypanosoma cruzi or Cestoda or Taenia or multiceps or Diphyllobothrium latum or Echinococcus or granulosus or Echinococcus or multilocularis or E. vogeli or E. oligarthrus or Hymenolepis nana or Hymenolepis diminuta or Taenia saginata or Taenia solium or Bertiella mucronata or Bertiella studeri or Spirometra or Erinaceieuropaei or Schistosoma haematobium or Schistosoma japonicum or Schistosoma mekongi or Echinostoma echinatum or Trichobilharzia regenti or Schistosomatidae or Ancylostoma or duodenale or Necator or americanus or Angiostrongylus or costaricensis or Anisakis or Ascaris sp. Ascaris or lumbricoides or Baylisascaris or procyonis or Brugia malayi or Brugia or timori or Dioctophyme renale or Dracunculus or medinensis or Enterobius or vermicularis or Enterobius gregorii or Gnathostoma or spinigerum or Gnathostoma or hispidum or Halicephalobus or gingivalis or Loa loa filaria or Mansonella or Streptocerca or Onchocerca volvulus or Strongyloides or stercoralis or Thelazia or californiensis or Thelazia callipaeda or Toxocara canis or Toxocara cati or Trichinella spiralis.

Similar to what is noted in connection to pathogenic target species, it should be understood that inhibition of parasitic target species need not be in or on an animal (including a human) body. Instead, the inhibition may also be outside the context of an animal body. For example, for inhibiting the target species in a culture. Selection of parasitic target species from skin parasites and/or gastrointestinal parasites and/or mucosal parasites is preferred, in particular selected from the list presented directly above. Selection of parasitic target species from protists or nematodes is preferred, in particular protists and nematodes from the list presented directly above. According to certain embodiments, the target species may be selected from a species pathogenic for a plant, such as a plant pathogen selected from fungi or Oomycetes or bacteria or protists or Fusarium spp. or Thielaviopsis spp. or Verticillium spp. or Magnaporthe spp. or Magnaporthe grisea or Sclerotinia spp. or Sclerotinia sclerotiorum or Phytophtora spp. or Pythium spp. Plasmodiophora spp. or Spongospora spp. or phytopathogenic bacilli or Erwinia spp. or Agrobacterium spp. or Burkholderia spp. or Proteobacteria or Xanthomonas spp. or Pseudomonas spp. or Phytoplasma spp. or Spiroplasma spp.

When the target species is selected as an infesting species, it may be selected from an agricultural pest, such as an agricultural pest arthropod such as a species selected from Acalymma or Acyrthosiphon kondoi or Acyrthosiphon gossypii or Acyrthosiphon pisum or African armyworm or Africanized bee or Agromyzidae or Agrotis ipsilon or Agrotis munda or Agrotis orthogonia or Agrotis porphyricollis or Akkaia taiwana or Aleurocanthus woglumi or Aleyrodes proletella or Alphitobius diaperinus or Alsophila aescularia or Altica chalybea or Anasa tristis or Anisoplia austriaca or Anthonomus pomorum or Anthonomus signatus or Aonidiella aurantii or Aonidiella citrina or Aonidiella orientalis or Apamea apamiformis or Apamea niveivenosa or Aphid or Aphis gossypii or Aphis nasturtii or Apple maggot or Argentine ant or Army cutworm or Fall armyworm or Arotrophora arcuatalis or Ash whitefly or Astegopteryx bambusae or Astegopteryx insularis or Astegopteryx minuta or Asterolecanium or Asterolecanium coffeae or Atherigona reversura or Athous haemorrhoidalis or Aulacophora or Aulacorthum solani or Australian plague locust or Bactericera cockerelli or Bactrocera or Bactrocera correcta or Bagrada hilaris or Knulliana or Beet armyworm or Black bean aphid or Blepharidopterus chlorionis or Bogong moth or Boll weevil or Bollworm or Brevicoryne brassicae or Brown locust or Brown marmorated stink bug or Brown planthopper or Cabbage moth or Cabbage worm or Callosobruchus maculatus or Carrot fly or Cerataphis brasiliensis or Ceratitis aliena or Ceratitis andranotobaka or Ceratitis capitata or Ceratitis flexuosa or Ceratitis grahami or Ceratitis ovalis or Ceratitis penicillata or Ceratitis rosa or Ceratoglyphina bambusae or Ceratopemphigus zehntneri or Ceratovacuna lanigera or Cereal leaf beetle or Chaetosiphon tetrarhodum or Chlorops pumilionis or Citrus long-horned beetle or Coccus hesperidum or Coccus viridis or Codling moth or Coffee borer beetle or Colias eurytheme or Colorado potato beetle or Common blossom thrips or Confused flour beetle or Cotton bollworm or Crambus or Cucumber beetle or Curculio elephas or Curculio nucum or Curculio occidentis or Cutworm or Cyclocephala borealis or Dargida diffusa or Dasineura brassicae or Date stone beetle or Delia (fly) or Delia antiqua or Delia floralis or Delia platura or Delia radicum or Dermestes ater or Dermolepida albohirtum or Desert locust or Diabrotica or Diabrotica balteata or Diabrotica speciosa or Diamondback moth or Diaphania indica or Diaphania nitidalis or Diaphorina citri or Diaprepes abbreviatus or Diatraea saccharalis or Differential grasshopper or Diparopsis castanea or Dociostaurus maroccanus or Drosophila suzukii or Dryocosmus kuriphilus or Dysaphis crataegi or Dysmicoccus brevipes or Earias perhuegeli or Epicauta vittata or Epilachna or Epitrix cucumeris or Epitrix tuberis or Erionota thrax or Eriosoma lanigerum or Eriosomatinae or Euleia heraclei or Eumetopina flavipes or European corn borer or Eurydema oleracea or Eurygaster integriceps or Ferrisia virgata or Forest bug or Frankliniella tritici or Galleria mellonella or Garden dart or Geoica lucifuga or Glassy-winged sharpshooter or Greenhouse whitefly or Greenidea artocarpi or Greenidea formosana or Greenideoida ceyloniae or Gryllotalpa orientalis or Gryllotalpa vinae or Gypsy moths in the United States or Helicoverpa armigera or Helicoverpa gelotopoeon or Helicoverpa punctigera or Helicoverpa zea or Heliothis virescens or Henosepilachna or Henosepilachna vigintioctomaculata or Henosepilachna vigintioctopunctata or Hessian fly or Heteronychus arator or Hyalopterus pruni or Hysteroneura setariae or Icerya purchasi or Ipuka dispersum or Jacobiasca formosana or Kaltenbachiella elsholtriae or Kaltenbachiella japonica or Khapra beetle or Lampides boeticus or Leaf miner or Lema daturaphila or Lepidiota consobrina or Lepidosaphes beckii or Lepidosaphes ulmi or Leptocybe invasa or Leptoglossus zonatus or Leptopterna dolabrata or Lesser wax moth or Leucoptera (moth) or Leucoptera caffeina or Light brown apple moth or Light brown apple moth controversy or Lipaphis erysimi or Liriomyza huidobrensis or Lissorhoptrus oryzophilus or Listronotus bonariensis or Long-tailed skipper or Lygus or Lygus hesperus or Macrodactylus subspinosus or Macrosiphoniella pseudoartemisiae or Macrosiphoniella sanborni or Macrosiphum euphorbiae or Maize weevil or Manduca sexta or Matsumuraja capitophoroides or Mayetiola hordei or Mealybug or Megacopta cribraria or Melanaphis sacchari or Melittobia australica or Metcalfa pruinosa or Mexican bean beetle or Micromyzus judenkoi or Micromyzus kalimpongensis or Micromyzus niger or Moth or Leek moth or Mythimna unipuncta or Myzus ascalonicus or Myzus boehmeriae or Myzus cerasi or Myzus obtusirostris or Myzus ornatus or Myzus persicae or Nematus or Nematus leucotrochus or Nematus ribesii or Nematus spiraeae or Neomyzus circumflexus or Neotoxoptera oliveri or Nezara viridula or Oak processionary or Oebalus pugnax or Olive fruit fly or Ophiomyia simplex or Opisina arenosella or Opomyza or Opomyza florum or Opomyzidae or Orseolia oryzae or Oryzaephilus mercator or Oscinella frit or Ostrinia furnacalis or Oxycarenus hyalinipennis or Papilio demodocus or Paracoccus marginatus or Paratachardina pseudolobata or Paropsisterna selmani or Patanga succincta or Pemphigus betae or Pentalonia nigronervosa or Pentatomoidea or Peridroma saucia or Phorodon humuli or Phthorimaea operculella or Phyllophaga or Phyllotreta nemorum or Phylloxeridae or Phylloxeroidea or Phytomyza horticola or Pieris brassicae or Pink bollworm or Planococcus citri or Platynota idaeusalis or Plum curculio or Prionus californicus or Pristiphora or Pseudoregma bambucicola or Pseudotheraptus wayi or Psylliodes chrysocephala or Ptinus fur or Pyralis farinalis or Raphidopalpa foveicollis or Red imported fire ant or Red locust or Rhagoletis cerasi or Rhagoletis indifferens or Rhagoletis mendax or Rhodobium porosum or Rhopalosiphoninus latysiphon or Rhopalosiphum maidis or Rhopalosiphum padi or Rhopalosiphum rufiabdominale or Rhyacionia frustrana or Rhynchophorus ferrugineus or Rhynchophorus palmarum or Rhynchophorus vulneratus or Rhyzopertha or Rice moth or Russian wheat aphid or Saissetia oleae or San Jose scale or Scale insect or Schistocerca americana or Schizaphis graminum or Schizaphis hypersiphonata or Schizaphis minuta or Schizaphis rotundiventris or Schoutedenia lutea or Sciaridae or Scirtothrips dorsalis or Scutelleridae or Scutiphora pedicellata or Serpentine leaf miner or Setaceous Hebrew character or Shivaphis celti or Silver or Silverleaf whitefly or Sinomegoura citricola or Sipha flava or Sitobion avenae or Sitobion lambersi or Sitobion leelamaniae or Sitobion miscanthi or Sitobion pauliani or Sitobion phyllanthi or Sitobion wikstroemiae or Sitona lepidus or Sitona lineatus or Small hive beetle or Southwestern corn borer or Soybean aphid or Spodoptera cilium or Spodoptera litura or Spotted cucumber beetle or Spotted lanternfly or Squash vine borer or Stemborer or Stenotus binotatus or Strauzia longipennis or Striped flea beetle or Sunn pest or Sweetpotato bug or Synanthedon exitiosa or Tarnished plant bug or Tecia solanivora or Tetranychus urticae or other Tretranychus spp., Tetraneura nigriabdominalis or Tetraneura yezoensis or Thrips or Thrips angusticeps or Thrips palmi or Thrips simplex or Thrips tabaci or Thysanoplusia orichalcea or Tinocallis kahawaluokalani or Toxoptera aurantii or Toxoptera citricida or Toxoptera odinae or Trichobaris trinotata or Trioza erytreae or Turnip moth or Tuta absoluta or Uroleucon minutum or Varied carpet beetle or Vesiculaphis caricis or Virachola isocrates or Waxworm or Western corn rootworm or Western flower thrips or Wheat fly or Wheat weevil or Whitefly or Winter moth or Xylotrechus quadripes or Zygogramma exclamationis. According to certain embodiments, selection of a target species from the order Lepidoptera is preferred, in particular selected from the family Tortricidae, such as from the genus Choristoneura, in particular Choristoneura orae, Choristoneura fumiferana or Choristoneura freemani, or selected from the family Noctuidae, such as the genus Spodoptera, in particular Spodoptera frugiperda, Spodoptera litura, Spodoptera litoralis, Spodoptera cilium or Spodoptera ornithogalli, or selected from the family Pyralidae, such as from the genus Plodia or Ephestia, or selected from other species from this order motioned in the list directly above. An agricultural pest species may also be selected from a phytophagous terrestrial gastropod species.

A pest species may further be selected from a disease vector, such as a disease vector selected from arthropods. The disease vector may be involved in the spreading of an animal disease, including a human disease, or may vector a plant disease. Diseases vectors vectoring animal diseases may be selected from blood feeding (haematophagous) or haemolymph feeding arthropods, preferably a blood feeding arthropod, for example selected from the family Culicidae, such as from the genus Aedes, or the family Ceratopogonidae, such as form the genus Culicoides, or the family Tabanidae, or from the family Simuliidae, such as from the genus Austrosimulium, or the family Glossinidae, such as from the genus Glossina, or the family Triatominae, such as Triatoma infestans or Rhodnius prolixus, or from the Siphonoptera, such as from the Publicidae, or from the Phthiraptera, such as from the genus Pediculus, or from the family Ixodidae, or from the family Argasidae. Arthropod vectors involved in spreading plant diseases may be selected from Acyrthosiphon pisum or Agromyzidae or Anastrepha grandis or Anastrepha obliqua or Anthomyiidae or Aphids or Bark beetles or Beet leafhoppers or Brevicoryne brassicae or Cacopsylla melanoneura or Cacopsylla ulmi or Ceratitis podocarpi or Chaetosiphon fragaefolii or Cicadulina or Cicadulina mbila or Common brown leafhopper or Cryptococcus fagisuga or Curculionidae or Diabrotica balteata or Empoasca decedens or Eumetopina flavipes or Euscelis plebejus or Frankliniella tritici or Glassy-winged sharpshooter or Haplaxius crudus or Hyalesthes obsoletus or Hylastes ater or Leaf beetle or Leafhopper or Lipaphis erysimi or Macrosteles quadrilineatus or Mealybug or Melon fly or Molytinae or Pegomya hyoscyami or Pissodes or Pissodes strobi or Pissodini or Planthopper or Pseudococcus maritimus or Pseudococcus viburni or Psylla pyri or Psyllidae or Rabdophaga clavifex or Rhynchophorus palmarum or Scaphoideus titanus or Scirtothrips dorsalis or Silverleaf whitefly or Tephritidae or Thripidae or Thrips palmi or Tomicus piniperda or Toxoptera citricida or Treehopper or Triozidae or Western flower thrips or Xyleborus glabratus.

According to certain preferred embodiments a pest species is selected as a nematode species parasitic to plants, in particular selected from the genus Meloidogyne, such as M. arenaria, M. incognita, M. javanica, or M. hapla, or selected from the genus Hetrodera, such as Heterodera glycines, or Heterodera avenae and H. filipjevi, or selected from the genus Globodera, such as Globodera pallida, or G. rostochiensis, or selected from the genus Pratylenchus, such as P. penetrans, P. thornei, P. neglectus, P. zeae, P. vulnus or P. coffeae, or selected from the genus Radopholus, such as Radopholus similis.

According to certain embodiments, infesting species may be selected from weed species. Weed species considered as target species within the present invention are for example weed species from the Alismataceae or Apiaceae or Asteraceae or Amaranthaceae or Cactaceae or Caryophyllaceae or Chenopodiaceae or Caulerpaceae or Commelinaceae or Poaceae or Portulacaceae or Euphorbiaceae or Fabaceae (Leguminosae) or Rubiaceae or Hydrocharitaceae or Azollaceae or Salviniaceae or Iridaceae or Liliaceae or Pontederiaceae or Melastomataceae or Myrtaceae or Polygonaceae or Lygodiaceae or Rosaceae or Acanthaceae or Orobanchaceae or Scrophulariaceae or Convolvulaceae or Cuscutaceae or Solanaceae or Sparganiaceae.

Specific weed species considered as target species may be selected from Sagittaria sagittifolia Linnaeus or Heracleum mantegazzianum Sommier & Levier or Ageratina adenophora (Spreng.) King & H. E. Robins. or Ageratina riparia (Regel) King & H. E. Robins. or Arctotheca calendula (L.) Levyns or Carthamus oxyacanthus M. Bieberstein or Crupina vulgaris Cass. or Inula britannica L. or Mikania cordata (Burm. f.) B. L. Robins. or Mikania micrantha Kunth or Onopordum acaulon L. or Onopordum illyricum L. or Senecio inaequidens DC. or Senecio madagascariensis Poir. or Tridax procumbens L. or Alternanthera sessilis (L.) R. Br. ex DC. or Opuntia aurantiaca Lindley or Drymaria arenarioides Humboldt & Bonpland or Salsola vermiculata L. or Caulerpa taxifolia (Vahl) C. Agardth or Commelina benghalensis L. or Avena sterilis Linnaeus or Chrysopogon aciculatus (Retz.) Trin. or Digitaria abyssinica (A. Rich) Stapf or Digitaria velutina (Forsk.) Beauv. or Imperata brasiliensis Trinius or Imperata cylindrica (L.) Beauv. or Ischaemum rugosum Salisbury or Leptochloa chinensis (L.) Nees or Nassella trichotoma Hackel ex Arech. or Oryza longistaminata A. Chev. & Roehr. or Oryza punctata Kotzchy ex Steud. or Oryza rufipogon Griffiths or Paspalum scrobiculatum Linnaeus or Pennisetum clandestinum Hochst. ex Chiov. or Pennisetum macrourum Trinius or Pennisetum pedicellatum Trinius or Pennisetum polystachion (Linnaeus) Schultes or Rottboellia cochinchinensis (Lour.) W. D. Clayton or Saccharum spontaneum L. or Setaria pumila ssp. pallidefusca (Schumacher) B. K. Simon or Urochloa panicoides Beauvois or Euphorbia terracina L. or Acacia nilotica (L.) Willd. ex Delile or Galega officinalis L. or Mimosa diplotricha C. Wright ex Sauvalle or 15 Mimosa pigra L. or Prosopis alpataco R. A. Philippi or Prosopis argentina Burkart or Prosopis articulata S. Watson or Prosopis burkartii Muhoz or Prosopis caldenia Burkart or Prosopis calingastana Burkart or Prosopis campestris Griesbach or Prosopis castellanosii Burkart or Prosopis denudans Bentham or Prosopis elata (Burkart) Burkart or Prosopis farcta (Banks & Soland.) J. F. Macbr. or Prosopis ferox Griesbach or Prosopis fiebrigii Harms or Prosopis hassleri Harms ex Hassler or Prosopis humilis Gillies ex Hooker & Arnott or Prosopis kuntzei Harms ex Hassler or Prosopis pallida (Humb. & Bonpl. ex Willd.) Kunth or Prosopis palmeri S. Watson or Prosopis reptans Benth. or Prosopis rojasiana Burkart or Prosopis ruizlealii Burkart or Prosopis ruscifolia Griesbach or Prosopis sericantha Gillies ex Hook. & Arn. or Prosopis strombulifera (Lamarck) Bentham or Prosopis torquata (Cavan. ex Lagasca y Segura) DC. or Spermacoce alata Aubl. or Hydrilla verticillata (L. f.) Royle or Lagarosiphon major (Ridley) Moss or Ottelia alismoides (Linnaeus) Pers. or Azolla pinnata R. Brown or Salvinia auriculata Aublet or Salvinia biloba Raddi or Salvinia herzogii de la Sota or Salvinia molesta D. S. Mitchell or Moraea collina Thunb. or Moraea flaccida (Sweet) Steud. or Moraea miniata Andrews or Moraea ochroleuca (Salisb.) Drapiez or Moraea pallida (Baker) Goldblatt or Asphodelus fistulosus Linnaeus or Eichhornia azurea (Swartz) Kunth or Monochoria hastata (L.) Solms or Monochoria vaginalis (Burm. f.) K. Presl ex Kunth or Melastoma malabathricum L. or Melaleuca quinquenervia (Cav.) Blake or Emex australis Steinhall or Emex spinosa (Linnaeus) Campdera or Lygodium flexuosum (L.) Sw. (1801) (Mobot) or Lygodium microphyllum (Cav.) R. Br. or Rubus fruticosus L. or Rubus moluccanus L. or Hygrophila polysperma (Roxb.) T. Anders. or Aeginetia spp. L. or Alectra spp. Thunb. or Orobanche spp. (nonnative) L. or Limnophila sessiliflora (Vahl) Blume or Striga spp. Lour. or Ipomoea aquatica Forssk. or Cuscuta spp. L. or Lycium ferocissimum Miers or Solanum tampicense Dunal or Solanum torvum Sw. or Solanum viarum Dunal or Sparganium erectum L.

Species that cause product deterioration that may be selected as target species may be selected from spoilage microorganisms, such as selected from bacteria, such as Gram-negative rods, e.g. Pseudomonas spp., Shewanella spp., Gram-positive spore-formers, e.g. Bacillus spp., Clostridium spp., lactic acid bacteria and other Gram-positive bacteria, e.g. Brochothrix spp, Micrococcus spp., or Enterobacteriaceae, fungi, such as Zygomycetes, from the genus Penicillium, or the genus Aspergillus or yeasts such as Zygosaccharomyces spp, Saccharomyces spp., Candida spp., Dekkera (Brettanomyces) spp. Alternatively, target species that cause product deterioration may be selected from stored product mites, such as selected from the Astigmata, such as selected from the Glycyphagidae, or the Carpoglyphidae.

The present invention will now be described, for illustrative but not limitative purposes, with particular reference to some illustrative examples and to the figures of the attached drawings, in which:

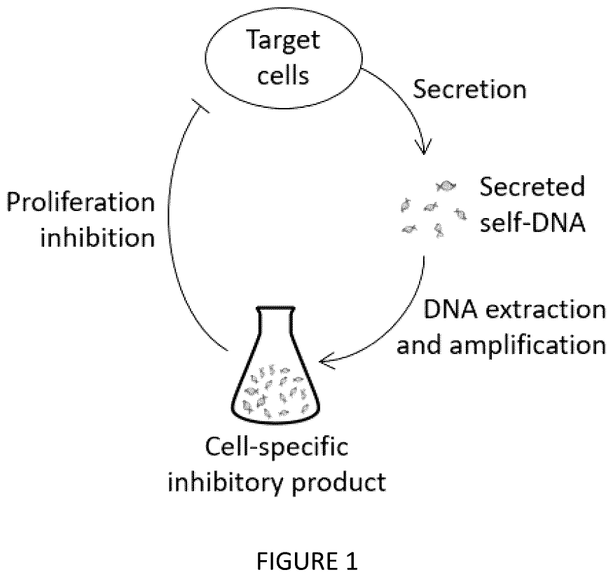

FIG. 1 shows a schematic representation of the discovery of a cell-specific inhibitory product produced by the secreted DNA of the same cell population.

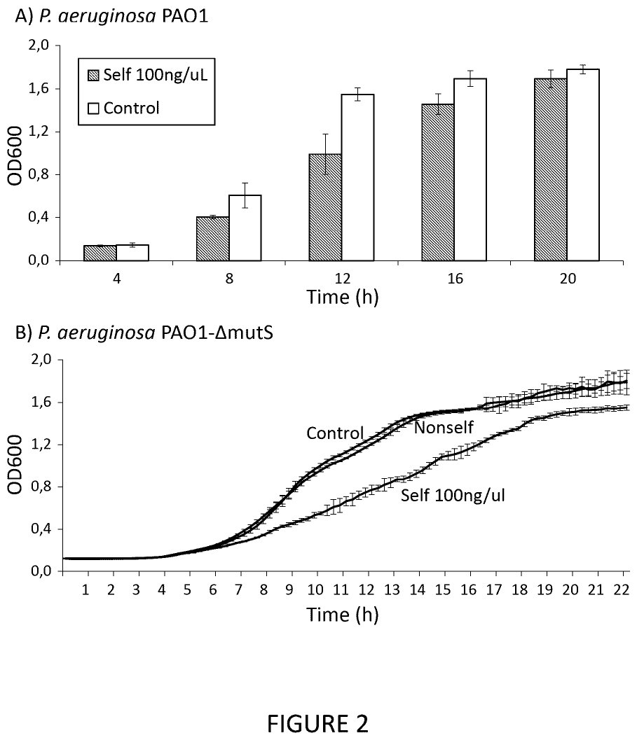

FIG. 2 shows the growth of two strains of P. aeruginosa. A) P. aeruginosa PAO1 control compared to exposure to fragmented genomic self-DNA. B) P. aeruginosa AmutS) control compared to exposure to either fragmented genomic self-DNA and nonself-DNA (salmon). DNA treatments were at the concentration of 100 ng/μL. Vertical bars represent standard deviations of three replicates.

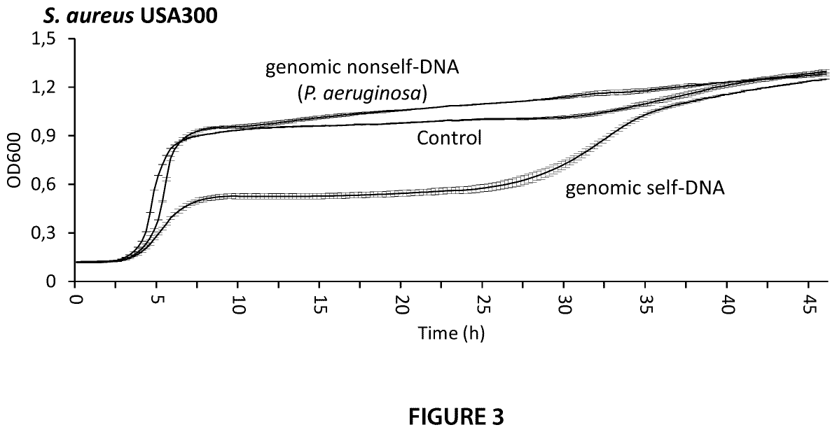

FIG. 3 shows the growth curves of S. aureus in presence of genomic self-DNA and heterologous (nonself—P. aeruginosa) at 50 ng/μl. Vertical bars represent standard deviations of three replicates.

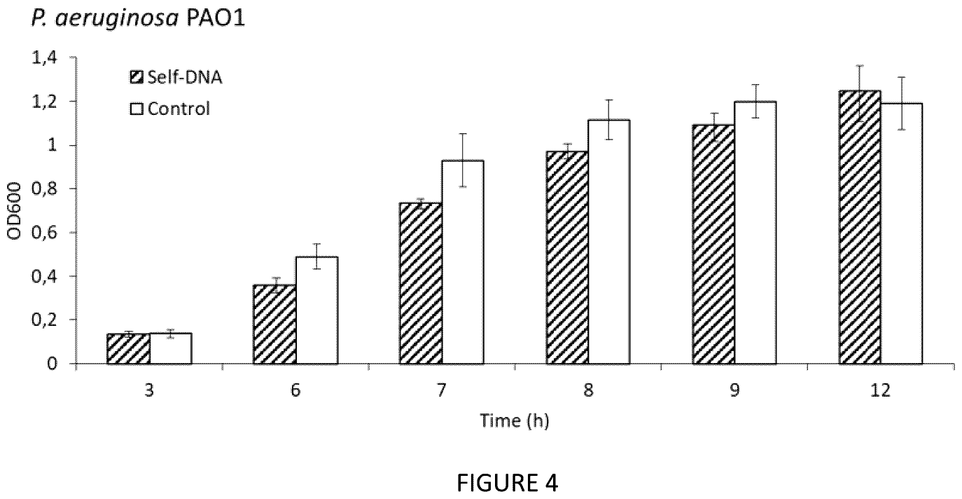

FIG. 4 shows the growth of P. aeruginosa PAO1 exposed to secreted self-DNA at the concentration of 6 ng/μL (white bars: control; black bars: secreted self-DNA extracted from supernatants of previous cultivation of the same strain containing only living cells).

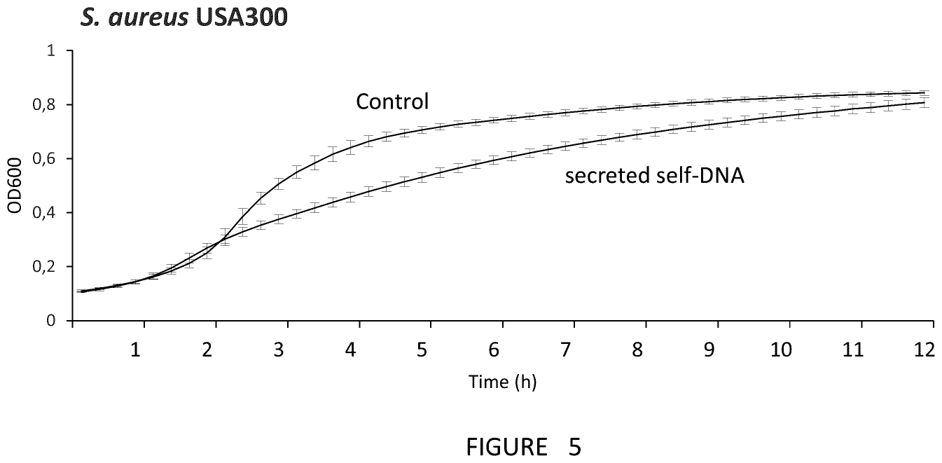

FIG. 5 shows the growth of S. aureus exposed to secreted self-DNA at the concentration of 6 ng/μL (secreted self-DNA extracted from supernatants of previous cultivation of the same strain containing only living cells).

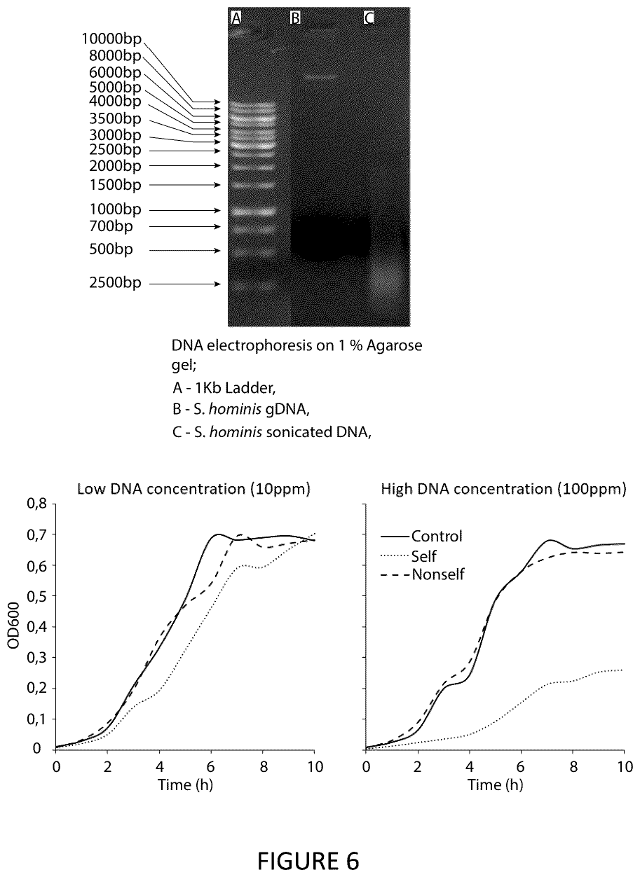

FIG. 6 shows the growth curves of S. hominis and dosage effect in presence of genomic self-DNA and heterologous (nonself—Malassezia) at both 10 and 100 ng/μl.

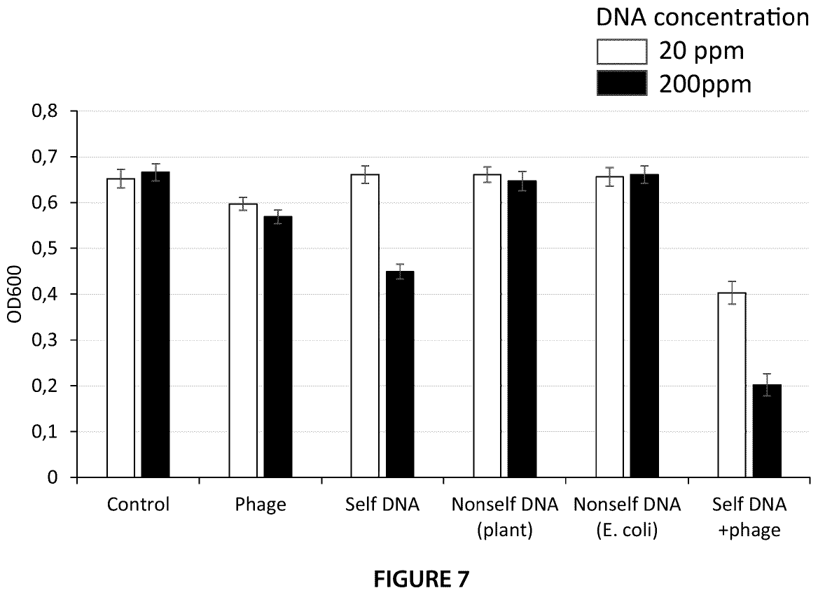

FIG. 7 shows the effect of genomic self-DNA on Klebsiella pneumoniae and the synergistic effect when combined with phage treatment. Experiments were performed with two sets of DNA concentrations (20 and 200 ppm).

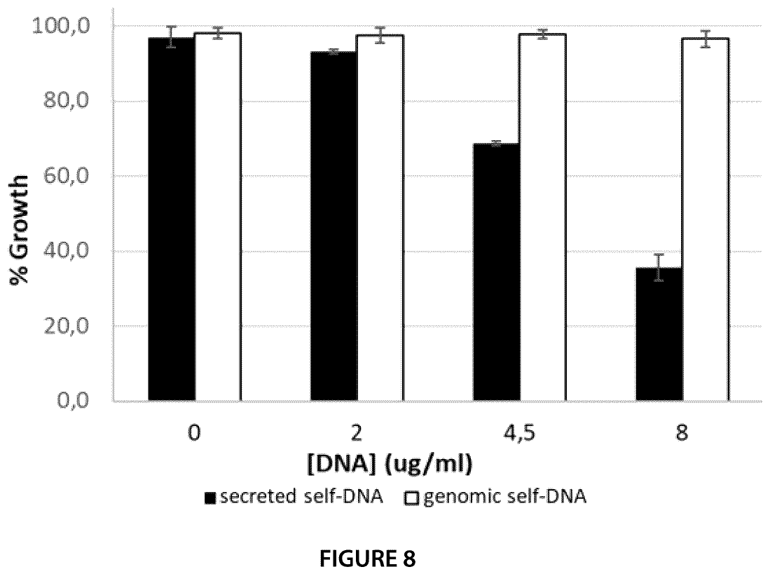

FIG. 8 shows a comparison between the inhibitory effect exerted by secreted self-DNA (black bars) and genomic self-DNA (white bars) on Saccharomyces cerevisiae growth at 24 h.

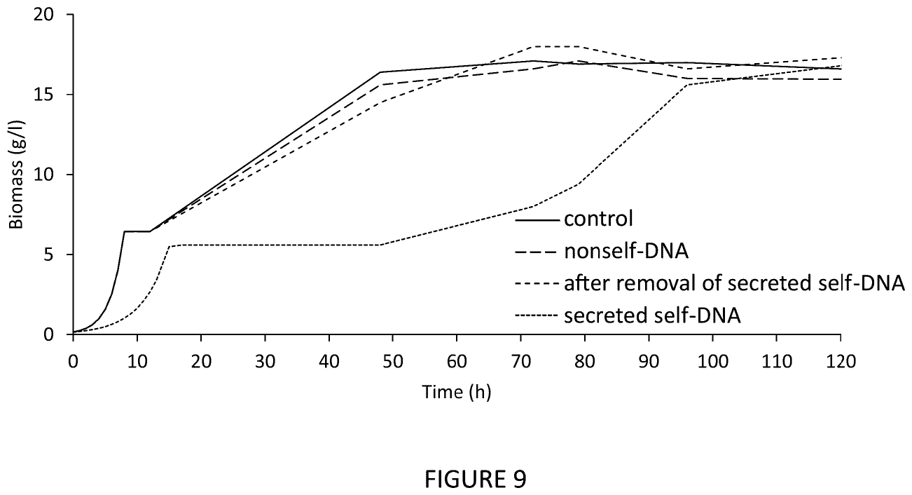

FIG. 9 shows the growth inhibition in Saccharomyces cerevisiae by exhausted medium containing secreted self-DNA compared to control, HAP exhausted medium after secreted self-DNA removal, and heterologous DNA (nonself DNA); the exhausted medium was obtained by cell culture containing only living cells.

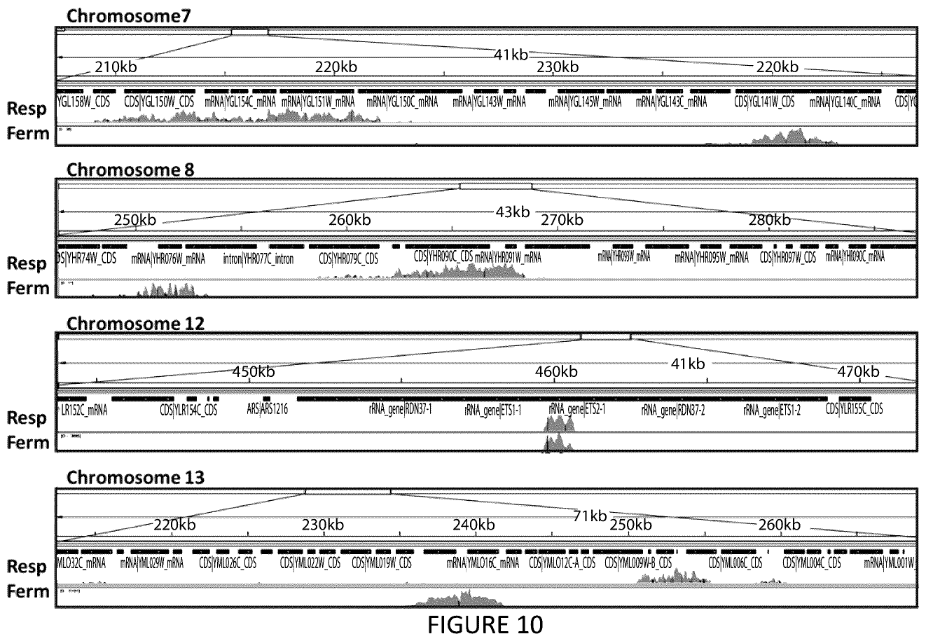

FIG. 10 shows examples of mapping on the genome of S. cerevisiae of DNA fragments recovered from respiratory and fermentative supernatants.

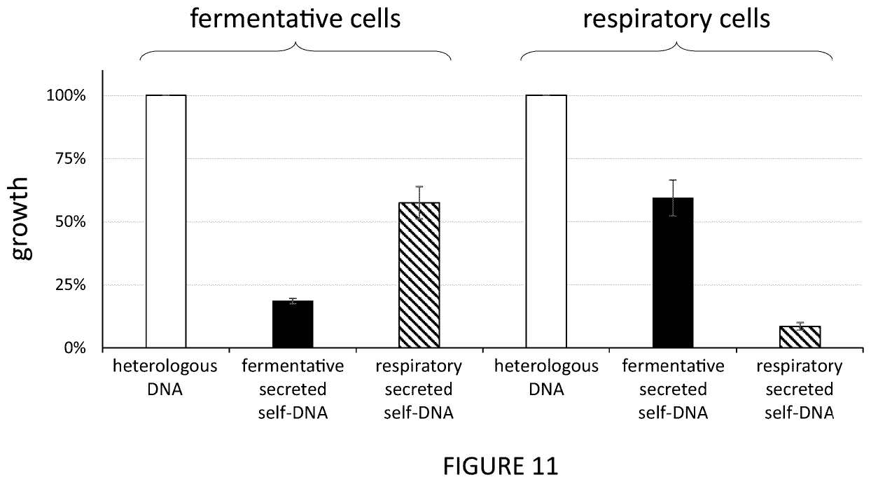

FIG. 11 shows the growth inhibition by secreted DNA recovered from media of S. cerevisiae growing either on glucose (fermentative cells, 7 h incubation) or on glycerol (respiratory cells, 48 h incubation); the media were obtained by cell culture containing only living cells. Heterologous DNA does not produce any growth inhibition independently of the metabolic status of target cells. Data are mean values of O.D.₅₉₀ assessed during growth and expressed as percentage of untreated control (=100).

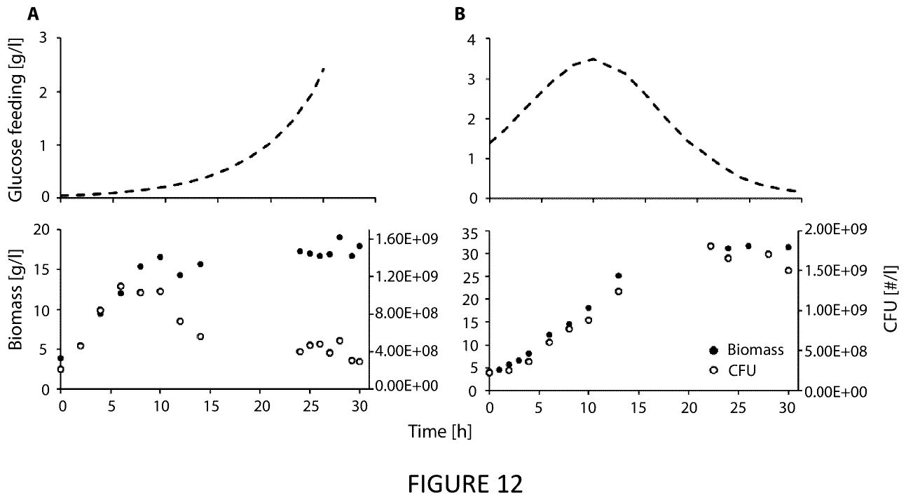

FIG. 12 shows the increased cell death in yeast cells grown in bioreactor when inhibited by the accumulation of secreted DNA and exposed to high sugar concentration.

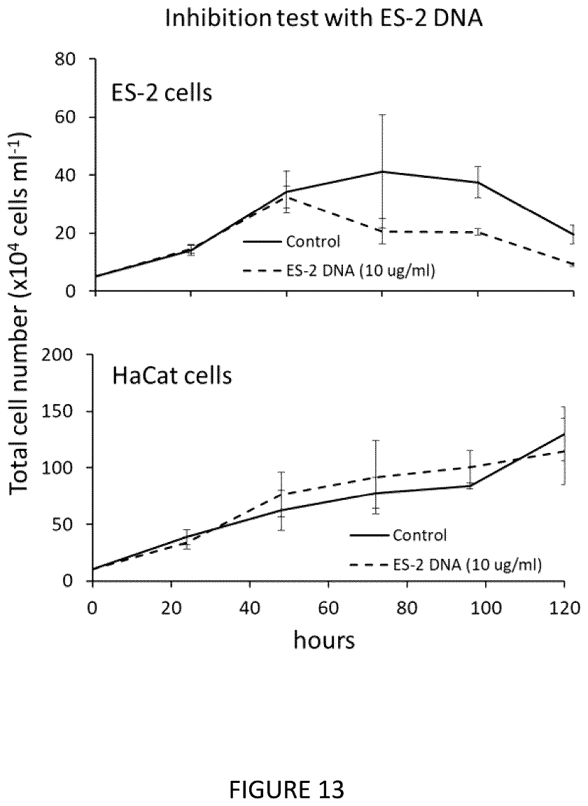

FIG. 13 shows the differential inhibitory effect of tumoral DNA on tumoral cells (ES-2) vs. healthy cells (HaCat).

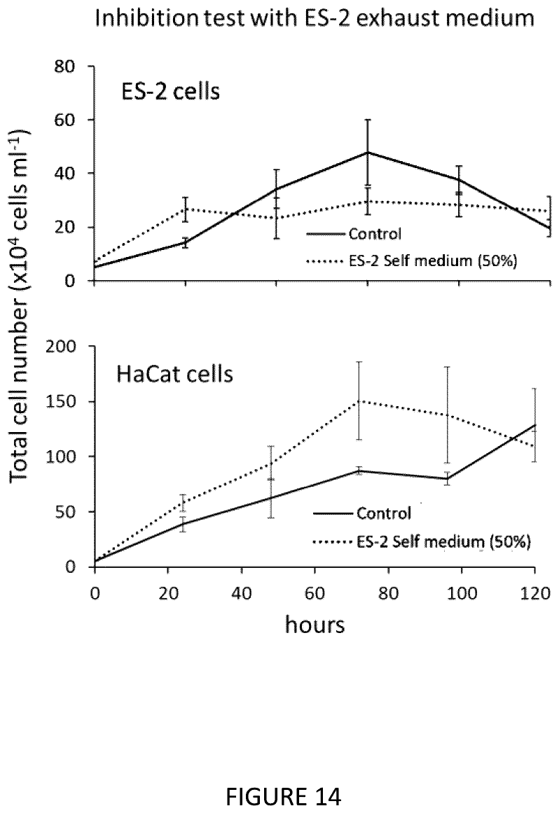

FIG. 14 shows the differential inhibitory effect of tumoral secreted DNA contained in exhausted growth media on tumoral cells vs. healthy cells; the exhausted medium was obtained by cell culture containing only living cells.

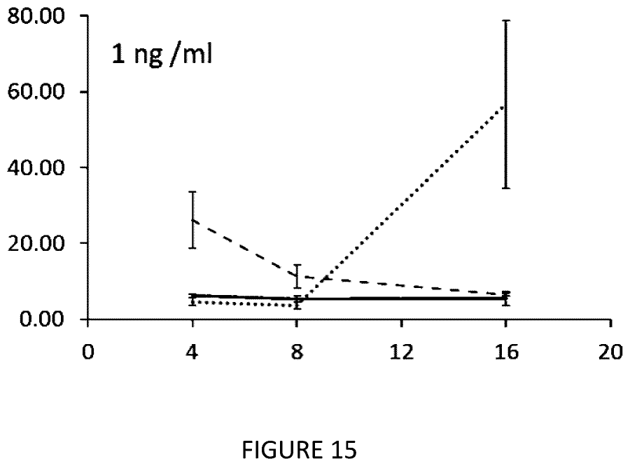

FIG. 15 shows HK-2 cell death (%) in control conditions (black line) and exposed to 1 ng/ml of either genomic self-DNA (dotted line) or nonself-DNA from PCCL3 cell line (dashed line).

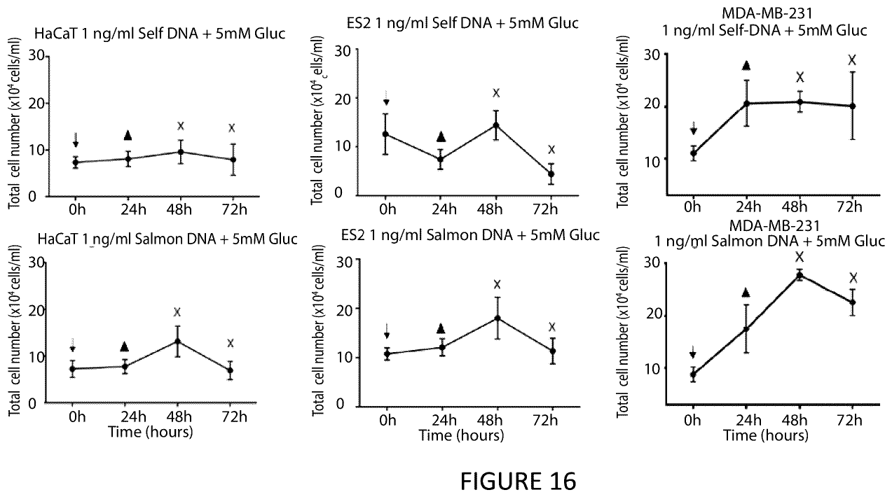

FIG. 16 shows the effect of genomic extracellular DNA and glucose boost on human cell lines (HaCat, ES-2 and MDA-MB-231). The glucose boost (triangle) was given after 24 h from exposure to DNA (vertical arrow).

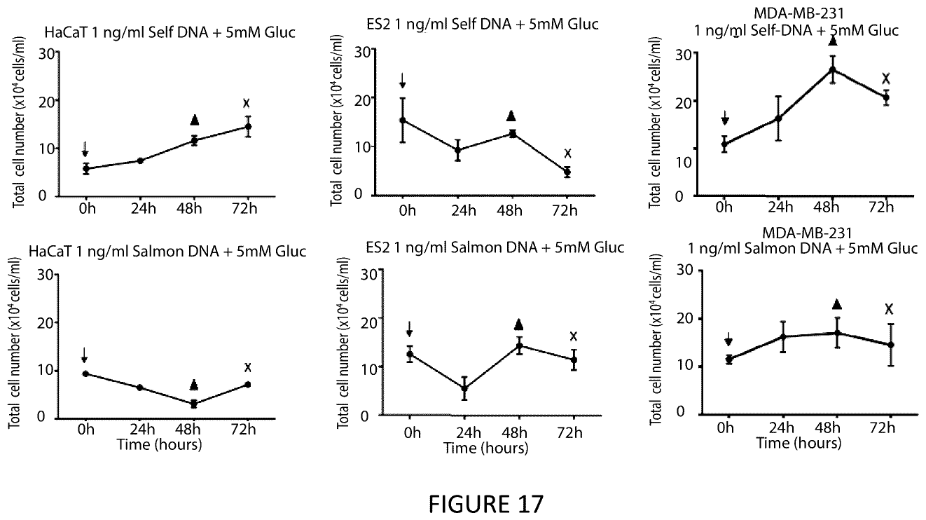

FIG. 17 shows the effect of genomic extracellular DNA and glucose boost on human cell lines (HaCat, ES-2 and MDA-MB-231). The glucose boost (triangle) was given after 48 h from exposure to DNA (vertical arrow).

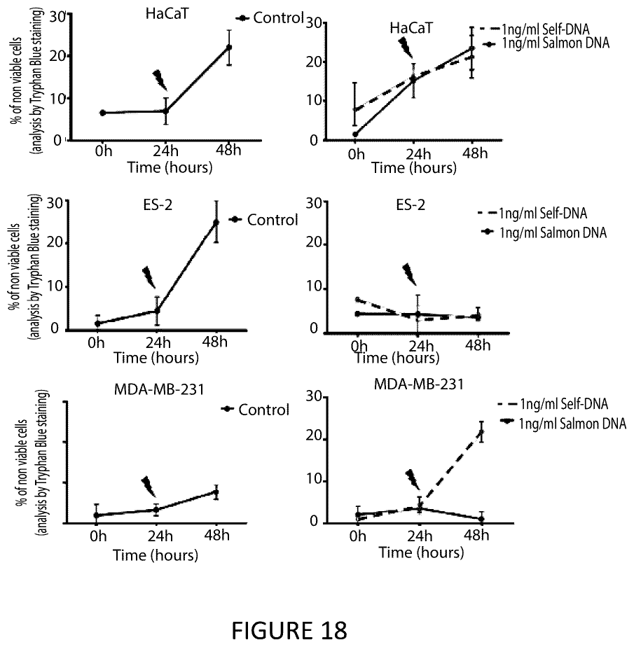

FIG. 18 shows the effect of genomic extracellular DNA and cisplatin on different human cell lines (HaCat, ES-2 and MDA-MB-231). The lightning bolt symbols represent cisplatin treatments.

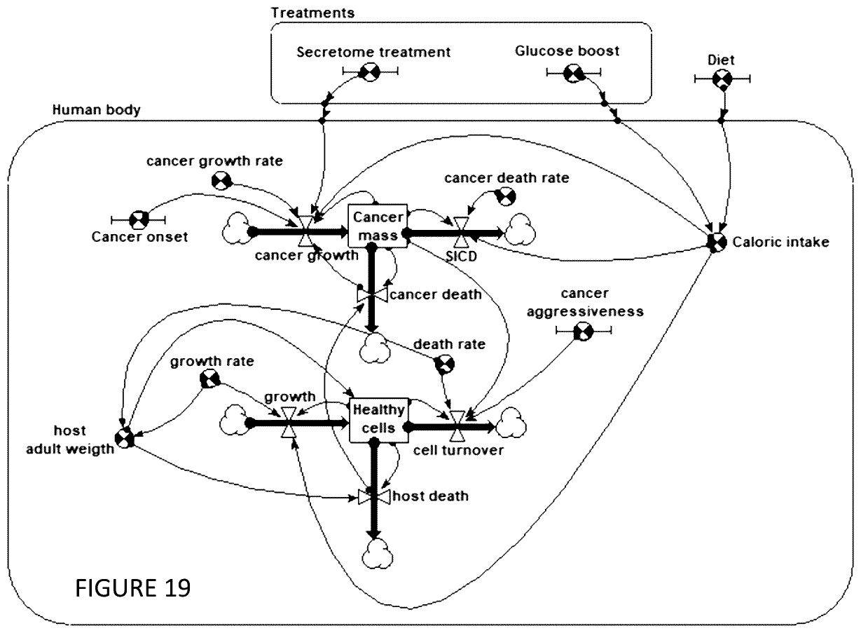

FIG. 19 shows a schematic representation of the simplified System Dynamics model of the interactions between healthy and cancer cell populations in a human body. See text for details.

FIG. 20 (A) schematic representation of a combined therapy by treatment with secreted DNA from cancer tissues with application of glucose pulse to induce selective apoptosis of cancer cells. (B) graphical explanation of the administration of secreted DNA of a specific cancer carried by microalgae used as food integrator and natural carrier of the target DNA.

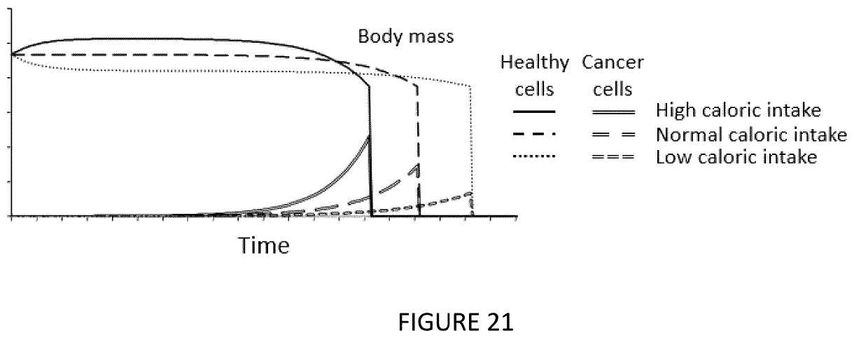

FIG. 21 shows a theoretical model simulation describing the relations between different levels of caloric intake, cancer progression and life expectancy.

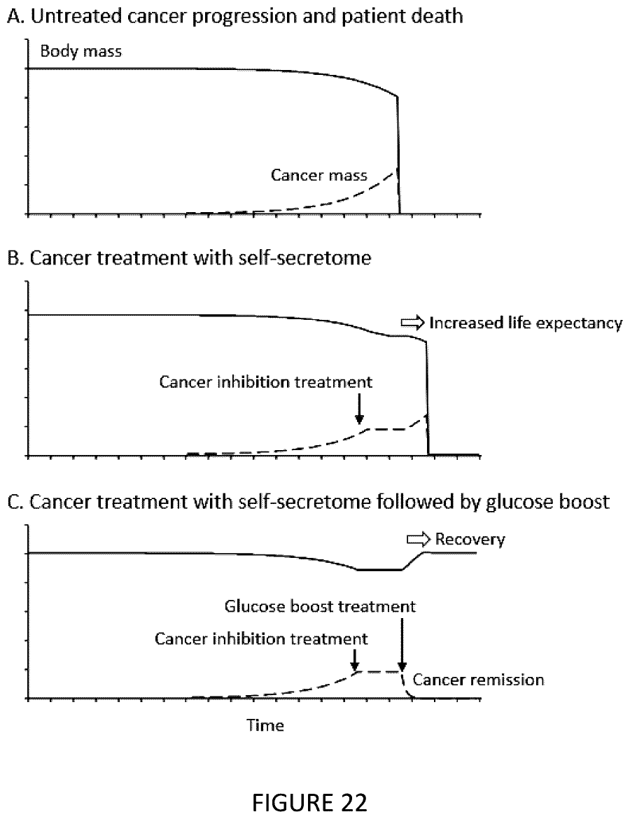

FIG. 22 shows a theoretical model simulation of cancer progression under different treatments. A) Untreated deadly cancer. B) Cancer treated with secreted self-DNA resulting in slower progression and increase in life expectancy. C) Integrated cancer treatment with secreted self-DNA followed by glucose boost resulting in total cancer remission due to induction of Sugar Induced Cell Death (SICD) in tumoral cells by their specific growth inhibition.

### EXAMPLES

### Examples 1-3: Experiments on Bacteria

All strains used in example 1 were retrieved from the strain library of the Laboratory of Microbial Genomics of the “Department of Cellular, Computational and Integrative Biology” of the University of Trento. The bacteria used in examples 2-3 were cultivated by BioEra Life Sciences Pvt. Ltd., India.

The following experiments show the decrease in dosage of self-secreted DNA compared to genomic self-DNA, the specificity of secreted self-DNA, and the enhanced effect obtained by the combination of the treatment with phage and treatment with self-DNA.

### Example 1: Inhibitory Effect of Genomic Self-DNA or Secreted Self-DNA on P. aeruginosa, Staphylococcus aureus, Staphylococcus hominis

### Methods

Strains of Pseudomonas aeruginosa (PAO1 and its hypermutable mutant PAO1-AmutS) and Staphylococcus aureus (USA300) were cultured in TSB medium in a volume of 200 μL in 96-wells microtiter plate and growth was monitored by OD₆₀₀ determination every 15 minutes using an Infinite M200 plate reader (Tecan, Männedorf, Switzerland) at 37° with orbital shaking at 180 rpm. Treatments were done by addition to the medium of either genomic self-DNA or secreted self-DNA. For comparison, commercial heterologous DNA from salmon fish was used in the case of P. aeruginosa experiments, whereas in the case of S. aureus experiments the heterologous DNA used was the genomic DNA from P. aeruginosa.

Genomic DNA was extracted from pelleted cells using the DNeasy Blood and Tissue kit (Qiagen, Hilden, Germany), following manufacturer instructions and including a step of digestion with RNAse cocktail (Ambion Inc., Austin, TX, United States). For S. aureus the extraction included an incubation with lysostaphin (Sigma-Aldrich, Darmstadt, Germany) during the cell lysis step.

Secreted self-DNA was obtained from supernatants of the bacterial species cultured in TSB using a standard commercial kit for cfDNA (cell-free DNA) extraction from plasma (NeoGenStar LLC, Somerset, NJ, USA). To reach the high concentrations and volumes needed, several extractions were pooled and concentrated using a CentriVap DNA Concentrator (Labconco). To ensure the extraction of only self-DNA secreted by living cells and avoid the presence of total genomic DNA, the extraction procedure was done on supernatants collected during the exponential growth phase when no cell death was observed.

The DNA concentration was measured using Qubit (ThermoFisher, Walthan, MA, USA), the purity was assessed through the evaluation of the 260/280 and 260/230 ratios using a Nanodrop ND-1000 spectrophotometer (ThermoFisher, Walthan, MA, United States) and the integrity were checked on 1% agarose gel.

Extracted genomic DNA was sonicated using a Bioruptor®sonicator (Diagenode, Liege, Belgium). The sonication protocol included 30/30 seconds on/off for 30 cycles, obtaining fragment average size of 200 bp ranging between 50 and 1000 bp).

### Results

Inhibitory Effect of Genomic Self-DNA on P. aeruginosa

The inhibitory effect of genomic DNA was tested in P. aeruginosa. Two strains were used PAO1 and its hypermutable mutant PAO1-AmutS. A significant inhibitory effect was observed at a concentration of 100 ng/μL in both selected strains (FIG. 2).

In the case of PAO1 strain, (FIG. 2A) the selected time-points of growth roughly corresponded to the four phases of the growth curve (lag-phase, early-exponential, late-exponential and plateau). The inhibition was more clearly visible at the mid- and late-exponential phase. The other strain PAO1-AmutS (FIG. 2B) showed to be inhibited at the same concentration of genomic self-DNA as found in the wild-type (100 ng/μL). No significant differences with control were observed with exposure to heterologous-DNA at the same concentration.

Inhibitory Effect of Genomic Self-DNA on Staphylococcus aureus

The experiment of exposure to genomic self-DNA showed a significant inhibition at a concentration of 50 ng/μL during the initial exponential phase of growth, followed by a lag phase lasting 15 hours and a recovery leading to the same cell density as the control after 36 hours (FIG. 3).

Inhibitory Effect of Secreted Self-DNA on P. aeruginosa

The exposure to secreted self-DNA showed an inhibitory effect detectable at lower concentration (6 ng/ul) than that observed with genomic DNA (100 ng/ul) for P. aeruginosa) (FIG. 4).

Inhibitory effect of secreted self-DNA on S. aureus The exposure to secreted self-DNA showed an inhibitory effect detectable at lower concentration (6 ng/ul) than that observed with genomic DNA (50 ng/μl for S. aureus) (FIG. 5).

### Example 2: Inhibitory Effect of Genomic Self-DNA on Staphylococcus hominis

### Methods

Experiments were carried out in 3 replicates at two different concentrations of sonicated DNA from S. hominis and Malassezia as heterologous DNA treatment at two concentrations 10 and 100 ng/ul. DNA was sonicated and quality and fragmentation levels were checked using 1% Agarose gel. LB nutrient broth till mid log phase for setting up the experiment replicates. From overnight grown culture an aliquot of 0.1 ml was aseptically inoculated to various experiment replicates. After addition, the culture tubes were incubated at 37° C. Samples were taken every hour from each replicate and checked by OD at 600 nm till the stationary phase was attained.

### Results

Inhibitory Effect of Genomic Self-DNA on Staphylococcus hominis

The experiment of exposure to genomic self-DNA showed a significant growth inhibition at a concentration of 100 ng/μL. At lower concentration (10 ng/μL) the inhibition is only visible during the initial exponential phase of growth, followed a recovery leading to the same cell density as the control after 36 hours (FIG. 6).

### Example 3: Inhibitory Effect of Genomic Self-DNA on Klebsiella Combined with Phage Treatment

A set of experiments was done to demonstrate that the species-specific inhibitory effect of self-DNA in bacterial species can be enhanced in combination with treatments with specific phages and/or by using secreted DNA of the target species instead of its whole genomic DNA.

### Methods

Experiments were carried out in 3 replicates of treatments with sonicated Self-DNA from Klebsiella pneumoniae (ATCC 33495—https://www.atcc.org/) and heterologous Nonself-DNA from a plant (Arabidopsis thaliana) and a different bacterial species (Escherichia coli). Treatments were done at two different concentrations 20 and 200 ng/μl. DNA was sonicated and quality and fragmentation levels were checked using 1% Agarose gel with fragment size ranging between 200 and 1000 bp. LB nutrient broth till mid log phase for setting up the experiment replicates. From overnight grown culture an aliquot of 0.1 ml was aseptically inoculated to the various experiment replicates. After addition, the culture tubes were incubated at 37° C. Phages were previously isolated from K. pneumoniae and phage lysates were added to the medium diluted 1:4. Samples were taken every hour from each replicate and checked by OD at 600 nm till the stationary phase was attained.

### Results

The self-DNA inhibition show a very strong synergistic effect when combined with phage treatment. The combined treatment is significantly more inhibitory than both phage and self-DNA alone (FIG. 7).

### Examples 4-7: Experiments on Yeast

The following experiments show the decrease in dosage of secreted self-DNA compared to genomic self-DNA, the specificity of secreted self-DNA and the enhanced effect of the combination of glucose treatment and self-DNA treatments.

### Example 4: Inhibitory Effect of Secreted Self-DNA and Genomic Self-DNA on S. cerevisiae Growth

### Methods

### Strain

The yeast strain used in all experiments was S. cerevisiae CEN.PK2-1C (MATa ura3-52 his3-D1 leu2-3,112 trpl-289 MAL2-8c SUC2), purchased at EUROSCARF collection (www.uni-frankfurt.de/fb15/mikro/euroscarf).

### DNA Extraction

S. cerevisiae genomic DNA was extracted from yeast cells collected after 24 h cultivation in YPD medium, by a commercial kit for genomic DNA (Quiagen, Valencia, CA) following the manufacturer's instructions.

S. cerevisiae secreted DNA was extracted from exhausted media collected at the end of S. cerevisiae aerobic fed-batch cultures performed in a 2.0 L stirred bioreactor (Bioflo110, New Brunswick Scientific) following two types of glucose feeding strategies: exponential or logistically decreasing, so that yeast growing population in the bioreactor displayed fermentative or respiratory metabolism, respectively, as thoroughly discussed in previously published work (Mazzoleni et. al, 2015). To ensure the extraction of only self-DNA secreted by living cells and avoid the presence of genomic DNA (total self-DNA), the absence of dead cells was checked with standard CFU assessment. Moreover, the DNA recovered from the supernatants was sequenced and found to correspond to a small portion of the total yeast genome.

The feeding solution, containing 50% glucose w/v and salts, trace elements, glutamic acid and vitamins, was pumped to the reactor at a specific feeding rate which was either exponentially increased during the run (exponential feeding) or logistically decreased following the yeast growth curve so that no glucose accumulated in the vessel in this latter feeding procedure. For sake of simplicity, hereafter the two exhausted media were named fermentative (F) and respiratory (R), respectively.

The exhausted media were recovered from the bioreactor and filtered (0.22 μm diameter Millipore filters) and used for DNA extraction. F exhausted medium was distilled at 37° C. under pressure, so that the residual ethanol was reduced down to 0.03% v/v. Ethanol was determined by Ethanol-enzymatic kit (Megazyme Intern.) No ethanol was present in R exhausted medium.

Then, the extraction of DNA from the exhausted medium was made according to Anker et al., (1975) with some modifications. The filtered medium (80 ml) was evaporated to dryness under vacuum to obtain 1.26 g dry weight. The dried material was suspended in 10 ml of preheated CTAB buffer (2% Cetyl trimethylammonium bromide, 1.4 M NaCl, 20 mM EDTA, 100 mM TrisHCl, pH 8.0) and incubated for 45 min at 40° C. An equal volume of phenol:chloroform:isoamyl alcohol (25:24:1) was added to CTAB solution and vortexed for 5 min. After centrifugation for 10 min (5000 rpm), the aqueous phase was collected and the phenol:chloroform:isoamyl alcohol treatment was repeated another time. The aqueous phase was collected, evaporated to dryness under vacuum and the dried extract was resuspended in 3 ml of H₂O (DNase/RNase free). The solution was then loaded on HAP (Hydroxyapatite DNA grade: Bio-Gel HTP) which was previously adapted in phosphate buffer solution (PBS, Na₂HPO₄ and NaH₂PO₄, pH 6.8) 0.005 M preheated at 60° C. The sample was mixed gently and incubated at room temperature for 10 min. The supernatant obtained from the centrifuge (5000 rpm, 5 min) was discarded and the sample containing the single-stranded DNA was eluted with PBS 0.12 M, while the double-stranded DNA was eluted with PBS 0.48 M. The DNA was quantified, and the exhausted medium after HAP treatment used for inhibition tests.

Direct Amplification of Secreted Self-DNA from Exhausted Medium

Both exhausted media (F and R) were directly subjected to amplification by using Replig kit (Quiagen, Valencia, CA). Then, the amplification product was subjected to sonication aiming at obtaining DNA fragments to be used in inhibitory experiments on yeast growth. Sonication was performed with a Bandelin Sonopulse (Bandelin, Berlin, Germany) at 90% power with a 0.9-s pulse for 12 min. Verification of sonicated band sizes (average size 200 bp) was performed on a 3% MetaPhor™ agarose gel (Lonza Scientific, Allendale, NJ, USA) using Sybr® Safe (Invitrogen).

Aliquots of the amplification products obtained with Replig were also used for sequencing. Standard bioinformatic procedures have been used for data analysis.

### Quantification of DNA

DNA deriving from extraction procedures or obtained by amplification was quantified by fluorimeter Qubit 3.0, using Qubit dsDNA and ssDNA assays Kits (Life Technology, Carlsbad, California, USA). The quality of samples was assessed by NanoDrop spectrophotometer (Thermo Fisher Scientific, Waltham, Massachusetts, USA).

### Inhibition Tests

The inhibitory tests on S. cerevisiae growth in the presence of genomic DNA, secreted self-DNA, or exhausted medium were performed in 25 ml-shake flasks containing 5 ml of a mineral medium supplemented with casamino acids, uracil, histidine, leucin, triptophan as already reported (Mazzoleni et al, 2015), and containing 2% w/v glucose or 6% v/v glycerol as carbon sources to allow yeast cells to growth under fermentative or respiratory conditions, respectively. The treatments were performed adding self-DNA at different concentrations to the growth medium coming from three different sources: total genomic self-DNA, secreted self-DNA, or aliquotes of either F or R exhausted medium (75% v/v final concentration). Cultures were inoculated with an adequate aliquot of a yeast pre-culture, to give an initial O.D.₅₉₀ of 0.1 and incubated at 28° C., 200 rpm.

As heterologous (nonself DNA), a commercial fish sperm DNA (Roche Diagnostics, Netherlands was used.

Yeast growth was monitored by determining cell density as optical density at 590 nm (O.D.₅₉₀). Cell viability was determined by viable plate count on YPD (yeast extract 1%, bactopeptone 2%, dextrose 2% w/v) agar plates incubated at 30° C. for 48 h. Viability was expressed as colony forming units (CFU) ml⁻¹. Data are mean values of O.D.₅₉₀ assessed during growth and expressed as percentage of untreated control (=100).

### Results

Inhibitory Effect of Secreted Self-DNA and Genomic Self-DNA on S. cerevisiae Growth

The inhibitory effect of secreted self-DNA (obtained by Replig amplification from the exhausted medium) on S. cerevisiae growth was assessed on yeast growth after 24 h incubation and compared with results obtained with genomic self-DNA.

In FIG. 8 it is clearly shown that secreted DNA inhibited yeast growth already at 4.5 ug/ml, achieving 35% of the control value at 8 μg/ml, whereas no inhibition at all was observed in the case of genomic self-DNA tested as the same concentrations. Genomic self-DNA, however, resulted inhibiting for yeast growth at one and even two higher orders of magnitudes: at 45 and 450 μg/ml, the percentage of growth control was 28 and 16, respectively (data not shown).

Inhibitory Effect of Secreted Self-DNA on S. cerevisiae Growth

The extraction of DNA from the exhausted medium following the procedure described in Methods, allowed us to quantify the amount of self-DNA accumulating during cultivation in the bioreactor due to yeast active secretion. The absence of dead cells was confirmed with standard CFU assessment and the exclusive presence of secreted DNA was confirmed by sequencing of the DNA recovered from the growth media that was found to correspond to only a small portion of the total yeast genome. The concentration of such secreted self-DNA in the exhausted medium was 1.2 ug/ml.

When the exhausted medium containing 1.2 ug/ml DNA was added to fresh yeast cultures, a clear inhibition of yeast growth was observed (FIG. 9): compared to the control, growth rate was decreased, and a very long diauxic lag phase rate was observed. After the lag phase, growth was resumed, and the final cell density achieved was the same as the control.

Contrarily, the exhausted medium, once DNA had been extracted by hydroxyapatite (HAP exhausted medium), was no more inhibiting for yeast growth (FIG. 9).

Considering that the exhausted medium was added at 75% v/v of the total culture volume for the inhibition tests, the effective inhibiting secreted DNA concentration was 0.90 ug/ml.

### Example 5: Secreted DNA Differences Between S. cerevisiae Cell Populations Grown Under Different Metabolic Conditions (Respiration Vs Fermentation)

Table 1 shows the differences between DNA fragments secreted by S. cerevisiae under respiratory and fermentative metabolism.

TABLE 1

| | Number | Number |
|---|---|---|
| | of contigs | of SPECIFIC |
| Condition | obtained | contigs |
| Fermentative | 2.142 | 1.093 |
| Respiratory | 12.032 | 10.932 |

In Table 1 the DNA fragments recovered from supernatants of S. cerevisiae cultures in either fermentative or respiratory conditions showed a major difference in terms of total number of contigs obtained by the bioinformatic analysis. Moreover, the number of specific sequences recovered by each growth medium in the two metabolic conditions represented 51 and 91% of the total number of the recovered sequences in the case of fermentative and respiratory conditions, respectively. In other words, the simpler more basic metabolism of fermentation corresponds to a lower amount of secreted fragments in the growth medium, whereas a dramatically higher amount of secreted fragments was found in the supernatants of cells exhibiting the more complex respiratory metabolism. It is very important to note that the two sets of secreted fragments included only 1049 DNA fragments shared in common between the two metabolic conditions, whereas the majority of accumulated fragments resulted to be specific of the growing conditions. FIG. 10 shows examples of secreted sequences mapped versus the reference yeast genome database resulting as corresponding to specific regions on different chromosomes. It is evident at a glance the different positions of the secreted sequences in either fermentative and respiratory conditions. Interestingly, the mapped regions overlapping in the case of the example on chromosome XII correspond to ribosomal gene which can be obviously expected to be active in both metabolic conditions (FIG. 10).

### Example 6: Process Specific Inhibitory Effect of Secreted Self-DNA on Growth of S. cerevisiae Fermentative and Respiratory Cells

To assess the effect of fermentative or respiratory secreted DNA (the exhausted media containing secreted self-DNA collected at the end of the fed-batch run when cell displayed a fermentative or a respiratory metabolism), the inhibition tests were performed in the presence of each secreted DNA on yeast cell cultures growing on glucose or on glycerol as carbon sources. Indeed, using glucose as carbon source, yeast growth was predominantly sustained by a fermentative metabolism in the first exponential phase, whereas yeast growth on glycerol was exclusively respiratory.

In FIG. 11 experimental evidence of growth inhibition by the two different secreted DNA (fermentative and respiratory) on S. cerevisiae growth is reported. The inhibitory effect is differentially higher when the treatment is done with the secreted DNA produced by yeast cells expressing the same metabolism (fermentative vs. respiratory).

### Example 7: Increased Cell Death in Inhibited Yeast Cells Exposed to Continuous Glucose Feeding

When an exponentially increasing glucose feeding is applied to a S. cerevisiae growing population in a bioreactor (see METHODS of example 4), cell mass increased following the imposed feeding rate, and achieves a maximum value of cell density (FIG. 12).

During the early phases of feeding, cell mass increased following the imposed feeding rate, and no residual glucose was detected in the culture medium. Afterwards, due to the accumulation of secreted self-DNA in the culture medium exerting an inhibitory effect, growth rate declines and glucose in the medium increases (FIG. 12). In parallel, a significant decrease of cell viability is observed (FIG. 12 a).

On the contrary, when a logistically decreasing glucose feeding is applied to a S. cerevisiae growing population in the bioreactor (see METHODS of example 4), glucose does not accumulate in the culture medium and no decrease in cell viability is observed all over the run though the final cell density reaches the same levels of the exponential feeding run (FIG. 12).

### Examples 8-12: Experiments on Human Cell Lines

The following experiments show the decrease in dosage of secreted self-DNA compared to genomic self-DNA, the specificity of secreted self-DNA and the enhanced effect obtained by combining the treatment with glucose and self-DNA treatments.

### Example 8: Inhibitory Effect of Tumoral DNA on Tumoral Cells Vs. Healthy Cells

### Methods

### Cell Culture

Two different cell lines were selected for this study: an immortalized keratinocyte cell line (HaCaT ATCC® PCS-200-011™) and an ovary clear cell carcinoma cell line (ES-2 ATCC® CRL-1978™). All cell lines were obtained from American Type Culture Collection (ATCC).

Cells were maintained at 37° C. in a humidified 5% CO2 atmosphere and cultured in Dulbecco's modified media (DMEM; 41965-039, Gibco, Thermo Fisher Scientific) supplemented with 10% foetal bovine serum (FBS; S0615, Merck), 1% Antibiotic-Antimycotic (AA; P06-07300, PAN Biotech) and 50 μg/ml gentamicin (15750-060, Gibco, Thermo Fisher Scientific). For each analysis, cells were detached with 0.05% trypsin-ethylenediaminetetraacetic acid (EDTA; 25300-054, Invitrogen, Thermo Fisher Scientific) at room temperature (RT) for approximately 5 min.

### Genomic Material Isolation

For DNA extraction, cells were plated in T-175 flasks and grown to ˜80% of confluence in supplemented DMEM. Cells were detached from the flask and collected. DNA extraction was performed using a Genomic DNA Purification Kit (CL-250, Citomed), according to the manufacture's recommendations. Salmon DNA was obtained commercially (Deoxyribonucleic acid, single stranded from salmon testes, D7656, Sigma-Aldrich, Merck).

All the DNA material used in this work was previously cleaved by sonication for 15 seconds (1 second On; 1 second Off). DNA was stored (−20° C.) until further use.

### Cell Proliferation Assessment

For cell proliferation analysis, 5×104 cells/well (1×105 cells/ml) of each cell line were seeded in 24-well plates (500 μl/well) in supplemented DMEM and left to adhere for 24 h. Cells were synchronized under starvation (culture medium with 1% FBS) for 24 h at 37° C. and 5% CO2, and exposed to the conditions in analysis: 1 ng/ml, 10 ng/mi, 100 ng/ml, 1 μg/ml, 10 μg/ml of self/heterologous DNA, or 10%, 50% or 100% exhausted media. Each 24 h, cells were detached as described (supernatant was also collected) and cells were centrifuged for 5 minutes at 155 g. Supernatant was discarded and cells were counted by staining with Trypan Blue Stain 0.4% (15250061, Gibco™, Thermo Fisher Scientific) to identify cells with a compromised cell membrane, hence indicating cell death, using a Neubauer improved cell counting chamber.

### Results

The effect of extracellular total genomic tumoral DNA (ES-2 cell line) on proliferation of the same tumoral cells and healthy cells (HaCat cell line) was studied. A differential response with a tendency for cell proliferation to decrease is the exposure to self-DNA, which is more evident after 48 hours of treatment compared to control (FIG. 13, upper panel).

### Example 9: Inhibitory Effect of Exhausted Medium Containing Tumoral Secreted DNA on Tumoral Cells Vs. Healthy Cells

### Methods

### Cell Culture

Two different cell lines were selected for this study: an immortalized keratinocyte cell line (HaCaT ATCC® PCS-200-011™) and an ovary clear cell carcinoma cell line (ES-2 ATCC® CRL-1978™). All cell lines were obtained from American Type Culture Collection (ATCC).

Cells were maintained at 37° C. in a humidified 5% CO2 atmosphere and cultured in Dulbecco's modified media (DMEM; 41965-039, Gibco, Thermo Fisher Scientific) supplemented with 10% foetal bovine serum (FBS; S0615, Merck), 1% Antibiotic-Antimycotic (AA; P06-07300, PAN Biotech) and 50 μg/ml gentamicin (15750-060, Gibco, Thermo Fisher Scientific). For each analysis, cells were detached with 0.05% trypsin-ethylenediaminetetraacetic acid (EDTA; 25300-054, Invitrogen, Thermo Fisher Scientific) at room temperature (RT) for approximately 5 min.

### Cell Proliferation Assessment

For cell proliferation analysis, 5×104 cells/well (1×105 cells/ml) of each cell line were seeded in 24-well plates (500 μl/well) in supplemented DMEM and left to adhere for 24 h. Cells were synchronized under starvation (culture medium with 1% FBS) for 24 h at 37° C. and 5% CO2, and exposed to the treatments. Each 24 h, cells were detached as described (supernatant was also collected) and cells were centrifuged for 5 minutes at 155 g. Supernatant was discarded and cells were counted by staining with Trypan Blue Stain 0.4% (15250061, Gibco™, Thermo Fisher Scientific) to identify cells with a compromised cell membrane, hence indicating cell death, using a Neubauer improved cell counting chamber.

The inhibitory effect of secreted DNA was assessed by adding exhaust media mixed (1:1 ratio) with standard culture medium as in cell proliferation assessment. Exhaust media were collected after maintaining cells in culture for 24 h.

### Results

Here the effect of exhaust medium of ES-2 cell lines was assessed on the same cell line and on a healthy cell line (HaCat). In this experiment, the exposure to exhaust medium containing the secreted DNA of ES-2 cells, clearly demonstrates the specific inhibitory effect on the same ES-2 cell line whereas the same exhaust medium is stimulatory on the HaCat cell line (FIG. 14).

### Example 10: Effect of Genomic Self-DNA and Nonself-DNA on Cell Death in Different Cell Lines

### Methods

### Cell Culture and DNA/Chromatin Extraction

Two cell lines were used: HK2—a proximal tubular cell line derived from normal kidney (cells immortalized by transduction with human papilloma virus 16 (HPV-16) E6/E7 genes); PCCL3—a rat (Rattus norvegicus) thyroid follicular cell line. These cell lines were maintained and cultured in DMEM F-12, DMEM or F-12 Coon's medium, respectively. Cell culture medium supplemented with 1% penicillin/streptomycin, 50 μg/ml gentamycin and 5% Fetal Bovine Serum (FBS).

To extract DNA cells were plated in T-175 cm2 and grown to ˜80% of confluence with cell culture medium supplemented with 1% FBS. Adherent cells were washed with PBS (1×) and scraped from the T-Flask. DNA extraction was performed using the manufacture's recommendations (Citogene). DNA was cleaved by sonication for 15 seconds (1 sec. ON; 1 sec. OFF). Chromatin was extracted from cells after protein fixation with formaldehyde (37%) and glycine (125 mM). Adherent cells were washed with PBS (1×) and scraped. Pellet cells were lysed by sonication, performing 32 cycles of 10 seconds each (1 sec. ON; 1 sec. OFF). DNA and chromatin fragmentation was confirmed by electrophoresis in a 2% agarose gel.

Cells were incubated with crescent DNA/chromatin concentrations: 1 ng/ml>10 ng/ml>100 ng/ml>1 μg/ml>10 μg/ml prepared in culture medium.

Assays were performed in 24 well plate with 5×104 cell/well and media was supplemented with 1% FBS. Cells were let to rest for 24 h before DNA/chromatin exposition.

### Flow Cytometry—Cell Death

Cell death analysis was performed using annexin V (FITC) and propidium iodide (PI) staining. Supernatants and adherent cells of each well were collected. Cells were washed with PBS (1×) with 0.5% BSA and incubated with annexin V. Cells were washed again to remove non-bonded annexin and prepared to flow cytometry analysis. PI was added prior to data acquisition. Data analysis was performed using FlowJo vX 0.7.

### Results

The full dataset of results at different dosages is reported in Table 2 and Table 3. A significant induction of cell death was observed after 16 h of exposure to self-DNA (HK-2) at the dosage of 1 ng/ml (FIG. 15).

Table 2 shows HK-2 cell death after exposure to self-DNA.

TABLE 2

| | Control | | 1 ng/ml 1 | | 10 ng/ml 1 | | 100 ng/ml 1 | | 1 ug/ml 1 | | 10 ug/ml 1 | |
|---|---|---|---|---|---|---|---|---|---|---|---|---|
| | avg | SD | avg | SD | avg | SD | avg | SD | avg | SD | avg | SD |
| 4 hours | | | | | | | | | | | | |
| Necrotic cells (%) | 2.06 | 0.66 | 2.79 | 1.24 | 2.86 | 0.17 | 2.29 | 0.44 | 1.42 | 0.72 | 1.74 | 0.68 |
| Late apoptotic cells (%) | 1.07 | 0.20 | 1.44 | 0.44 | 1.75 | 0.84 | 1.19 | 0.11 | 1.97 | 0.85 | 2.81 | 1.02 |
| Early apoptotic cells (%) | 0.24 | 0.08 | 0.35 | 0.09 | 0.39 | 0.11 | 0.30 | 0.07 | 0.39 | 0.10 | 0.49 | 0.20 |
| Live cells (%) | 96.63 | 0.49 | 95.40 | 0.96 | 94.97 | 1.09 | 96.23 | 0.49 | 96.23 | 0.34 | 94.97 | 1.17 |
| Total death (%) | 3.36 | 0.48 | 4.58 | 0.96 | 4.99 | 1.09 | 3.77 | 0.49 | 3.77 | 0.34 | 5.04 | 1.17 |
| 8 hours | | | | | | | | | | | | |
| Necrotic cells (%) | 1.23 | 0.42 | 2.26 | 0.99 | 1.22 | 0.37 | 1.54 | 0.14 | 0.75 | 0.31 | 1.06 | 0.18 |
| Late apoptotic cells (%) | 0.64 | 0.19 | 0.55 | 0.07 | 0.64 | 0.16 | 0.58 | 0.08 | 0.54 | 0.08 | 0.54 | 0.37 |
| Early apoptotic cells (%) | 0.56 | 0.14 | 0.76 | 0.41 | 0.87 | 0.11 | 0.75 | 0.14 | 1.05 | 0.20 | 1.29 | 1.04 |
| Live cells (%) | 97.60 | 0.14 | 96.40 | 0.94 | 97.30 | 0.29 | 97.10 | 0.14 | 97.67 | 0.17 | 97.10 | 1.27 |
| Total death (%) | 2.40 | 0.17 | 3.55 | 0.93 | 2.71 | 0.29 | 2.85 | 0.12 | 2.32 | 0.17 | 2.88 | 1.25 |
| 16 hours | | | | | | | | | | | | |
| Necrotic cells (%) | 0.94 | 0.38 | 0.42 | 0.18 | 0.32 | 0.11 | 0.17 | 0.08 | 0.16 | 0.04 | 1.84 | 1.82 |
| Late apoptotic cells (%) | 2.72 | 1.63 | 7.34 | 1.31 | 6.02 | 1.38 | 3.15 | 0.19 | 3.63 | 0.58 | 8.05 | 5.56 |
| Early apoptotic cells (%) | 2.13 | 0.57 | 48.87 | 21.05 | 16.00 | 6.14 | 1.27 | 0.41 | 3.64 | 3.22 | 2.87 | 1.14 |
| Live cells (%) | 93.47 | 1.48 | 43.40 | 22.13 | 77.67 | 4.82 | 95.40 | 0.54 | 92.57 | 3.68 | 87.23 | 8.37 |
| Total death (%) | 5.79 | 2.52 | 56.63 | 22.16 | 22.34 | 4.81 | 4.59 | 0.57 | 7.44 | 3.66 | 12.76 | 8.37 |

Table 3 shows HK-2 cell death after exposure to nonself-DNA from PCCL3 cell line.

TABLE 3

| | Control | | 1 ng/ml 1 | | 10 ng/ml 1 | | 100 ng/ml 1 | | 1 ug/ml 1 | | 10 ug/ml 1 | |
|---|---|---|---|---|---|---|---|---|---|---|---|---|
| | avg | SD | avg | SD | avg | SD | avg | SD | avg | SD | avg | SD |
| 4 hours | | | | | | | | | | | | |
| Necrotic cells (%) | 1.43 | 0.18 | 5.75 | 4.71 | 0.98 | 0.22 | 0.85 | 0.21 | 1.62 | 0.54 | 11.50 | 1.12 |
| Late apoptotic cells (%) | 6.30 | 0.60 | 17.57 | 2.33 | 7.09 | 1.30 | 6.88 | 0.65 | 6.92 | 1.18 | 5.55 | 0.34 |
| Early apoptotic cells (%) | 1.35 | 0.11 | 2.95 | 0.31 | 1.85 | 0.19 | 1.78 | 0.10 | 2.00 | 0.19 | 1.21 | 0.22 |
| Live cells (%) | 90.90 | 0.51 | 73.77 | 7.31 | 90.07 | 1.26 | 90.47 | 0.87 | 89.47 | 1.76 | 81.73 | 1.10 |
| Total death (%) | 8.94 | 0.50 | 26.13 | 7.35 | 9.78 | 1.23 | 9.37 | 0.87 | 10.40 | 1.73 | 18.12 | 1.16 |
| 8 hours | | | | | | | | | | | | |
| Necrotic cells (%) | 2.65 | 0.55 | 4.41 | 3.02 | 2.33 | 0.35 | 1.99 | 0.24 | 2.51 | 0.16 | 11.00 | 0.67 |
| Late apoptotic cells (%) | 5.09 | 1.06 | 5.73 | 0.70 | 6.41 | 0.94 | 6.39 | 0.28 | 7.24 | 0.31 | 7.43 | 1.44 |
| Early apoptotic cells (%) | 0.54 | 0.02 | 1.22 | 0.57 | 0.76 | 0.27 | 1.22 | 0.64 | 1.23 | 0.45 | 0.87 | 0.11 |
| Live cells (%) | 91.70 | 1.44 | 88.63 | 3.01 | 90.47 | 1.52 | 90.40 | 0.88 | 89.03 | 0.21 | 80.70 | 1.31 |
| Total death (%) | 8.22 | 1.44 | 11.28 | 3.01 | 9.43 | 1.50 | 9.53 | 0.90 | 10.91 | 0.20 | 19.23 | 1.31 |
| 16 hours | | | | | | | | | | | | |
| Necrotic cells (%) | 1.59 | 0.43 | 1.91 | 0.57 | 1.77 | 0.33 | 2.32 | 0.68 | 1.56 | 0.27 | 3.38 | 1.97 |
| Late apoptotic cells (%) | 2.77 | 0.99 | 3.56 | 0.82 | 3.12 | 0.35 | 3.20 | 0.46 | 3.39 | 0.77 | 4.52 | 0.87 |
| Early apoptotic cells (%) | 0.90 | 0.52 | 1.10 | 0.14 | 0.84 | 0.09 | 0.78 | 0.29 | 0.78 | 0.15 | 1.58 | 0.18 |
| Live cells (%) | 94.73 | 1.11 | 93.43 | 0.40 | 94.30 | 0.64 | 93.70 | 0.42 | 94.30 | 0.78 | 90.50 | 1.06 |
| Total death (%) | 5.15 | 1.13 | 6.47 | 0.39 | 5.63 | 0.65 | 6.19 | 0.44 | 5.63 | 0.80 | 9.39 | 1.03 |

### Example 11: Effect of Starvation and Glucose Boost on Human Cell Lines

### Methods

### Cell Culture

Three different cell lines were selected for this study: an immortalized keratinocyte cell line (HaCaT ATCC® PCS-200-011™); an ovary clear cell carcinoma cell line (ES-2 ATCC® CRL-1978™) and an epithelial human breast cancer cell line (MDA-MD-231 ATCC® HTB-26™). All cell lines were obtained from American Type Culture Collection (ATCC).

Cells were maintained at 37° C. in a humidified 5% CO2 atmosphere and cultured in Dulbecco's modified media (DMEM; 41965-039, Gibco, Thermo Fisher Scientific) supplemented with 10% foetal bovine serum (FBS; S0615, Merck), 1% Antibiotic-Antimycotic (AA; P06-07300, PAN Biotech) and 50 μg/ml gentamicin (15750-060, Gibco, Thermo Fisher Scientific). For each analysis, cells were detached with 0.05% trypsin-ethylenediaminetetraacetic acid (EDTA; 25300-054, Invitrogen, Thermo Fisher Scientific) at room temperature (RT) for approximately 5 min.

### Genomic Material Isolation

For DNA extraction, cells were plated in T-175 flasks and grown to ˜80% of confluence in supplemented DMEM. Cell were detached from the flask and collected. DNA extraction was performed using a Genomic DNA Purification Kit (CL-250, Citomed), according to the manufacture's recommendations. Salmon DNA was obtained commercially (Deoxyribonucleic acid, single stranded from salmon testes, D7656, Sigma-Aldrich, Merck).

All the DNA material used in this work was previously cleaved by sonication for 15 seconds (1 second On; 1 second Off). DNA was stored (−20° C.) until further use.

### Glucose Boost Assay

Cells (5×104 cells/well; 1×105 cells/ml) were seeded in 24-well plates (500 μl/well) in supplemented DMEM and left to adhere for 24 h. Media was then removed and replaced by non-supplemented DMEM without D-glucose and without L-glutamine (F0405, Biochrom, Merck). Conditions (self and heterologous DNA) were then added to the cells. D-glucose was added upon 24 h or 48 h cell adaptation and analysis was performed 1 h, 24 h or 48 h upon D-glucose treatment. Cell proliferation and cell death analysis was assessed as described before.

### Results

No effect of self-DNA treatment was evident in the HaCat cell line, also when accompanied with a glucose boost at 24 h (FIG. 16). The same cells exposed to heterologous DNA showed a positive reaction to the glucose boost at 24 h. A slight positive effect of the glucose boost at 48 h was observed in HaCat cell when exposed to both self and heterologous DNA (FIG. 17).

In the case of ES-2 the exposure to self-DNA shows an evident negative effect which is partially recovered by the glucose boost at 24 h with a total decline after 72 h (FIG. 16). When the glucose boost was given after 48 h no recover was observed with total decline of the population after 72 h (FIG. 17). In both cases, treatment with heterologous DNA did not produce a significant reduction of cell population after 72 h (FIG. 16 and FIG. 17).

MDA-MB-231 cell showed high resistance to both DNA and glucose treatments, independently of the time of glucose boost (FIG. 16 and FIG. 17).

These results further indicate that self-DNA exerts a differential effect in non-cancer and cancer cells, apparently harming or increasing sensitivity of cancer cells to glucose boost upon a starved period in the case of ES-2 cells.

### Example 12: Effect of Self/Heterologous DNA and Glucose Boost on Response to Cisplatin in Human Cell Lines

### Methods

### Cell Culture

Three different cell lines were selected for this study: an immortalized keratinocyte cell line (HaCaT ATCC® PCS-200-011™); an ovary clear cell carcinoma cell line (ES-2 ATCC® CRL-1978™) and an epithelial human breast cancer cell line (MDA-MD-231 ATCC® HTB-26™). All cell lines were obtained from American Type Culture Collection (ATCC).

Cells were maintained at 37° C. in a humidified 5% CO2 atmosphere and cultured in Dulbecco's modified media (DMEM; 41965-039, Gibco, Thermo Fisher Scientific) supplemented with 10% foetal bovine serum (FBS; S0615, Merck), 1% Antibiotic-Antimycotic (AA; P06-07300, PAN Biotech) and 50 μg/ml gentamicin (15750-060, Gibco, Thermo Fisher Scientific). For each analysis, cells were detached with 0.05% trypsin-ethylenediaminetetraacetic acid (EDTA; 25300-054, Invitrogen, Thermo Fisher Scientific) at room temperature (RT) for approximately 5 min.

### Genomic Material Isolation

For DNA extraction, cells were plated in T-175 flasks and grown to ˜80% of confluence in supplemented DMEM. Cells were detached from the flask and collected. DNA extraction was performed using a Genomic DNA Purification Kit (CL-250, Citomed), according to the manufacture's recommendations. Salmon DNA was obtained commercially (Deoxyribonucleic acid, single stranded from salmon testes, D7656, Sigma-Aldrich, Merck).

All the DNA material used in this work was previously cleaved by sonication for 15 seconds (1 second On; 1 second Off). DNA was stored (−20° C.) until further use.

### Effect of Self/Heterologous DNA and Glucose Boost on Response to Cisplatin

Cells were left to adapt for 24 h in DMEM free glucose, FBS and glutamine, and then exposed to the following treatments: 1 ng/ml self-DNA; 1 ng/ml salmon DNA; 1 ng/ml self-DNA+5 mM glucose; 1 ng/ml salmon DNA+5 mM glucose. After that, cells were treated with 0,025 mg/ml of cisplatin (corresponding to clinical dosage in cancer patients) and analysed cell proliferation and cell death. Cell death was assessed by staining with trypan blue and microscopy identification and count. This staining cannot distinguish between necrotic and apoptotic cells.

### Results

Finally, the effect of self and heterologous DNA on the response of different cell lines treated with cisplatin was studied. Cisplatin is a well-known chemotherapeutic drug that has been shown to be effective as treatment for numerous human cancers. Its mode of action has been linked to its ability to crosslink with the purine bases on the DNA, interfering with DNA repair mechanisms, causing DNA damage, and subsequently inducing apoptosis in cancer cells.

HaCaT cells, when treated with cisplatin, show an overall decrease in proliferation, which is explained by the increased cell death levels (FIG. 18). Neither self nor salmon DNA seem to exert a protective effect in HaCaT cells. Differently, in the case of ES-2 cells self and heterologous DNA seem to both promote a protective effect towards cisplatin, presenting substantially lower cell death values compared to control.

MDA-MB-231 cells were shown to be apparently resistant to self and heterologous DNA with/without glucose (FIG. 16 and FIG. 17). Moreover, this cell line is known to be highly resistant to cisplatin which was confirmed by this experiment (FIG. 18). However, interestingly, treatment with self-DNA highly increased the sensitivity of MDA-MB-231 cells to cisplatin, which could be a useful tool for this type of cancer treatment.

Overall, these results indicate an interesting interaction between extracellular DNA and chemotherapeutic drugs (in this case cisplatin).

### Example 13: Therapeutic Model for Tumours Combining Inhibition by Secreted DNA and SICD by Glucose Boost

In the presented experiments it was shown that different cell lines responded differently to either self or nonself secreted DNA. Moreover, the combination of growth inhibition with cancer secreted DNA and glucose boost produced positive results in some of the tested cell lines, supporting the idea of targeted use of self-DNA and induction of sugar induced cell death (SICD—see the example of ES-2 cells being sensitised in presence of glucose).

Moreover, similar results were achieved with a combination of secreted DNA inhibition and traditional chemotherapeutic drugs (cisplatin) as in the case of MDA-MB-231 showing a very high sensitivity to cisplatin only when starved and in presence of self-DNA. It is important to note that MDA-MB-231 cells are reported as resistant to cisplatin treatment.

### Methods

### Model Development

A simplified mathematical model of cancer development has been implemented according to the approach of System Dynamics. The system of Ordinary Differential Equations represents the growth dynamics of: i) the cell population of a healthy organism and ii) a cancer cell population. Both cell populations grow in relation to the nutrient availability (i.e., caloric intake) and cancer cells exert a negative effect on the host organism which can lead to death if above a set threshold (reflecting loss of the minimal necessary functionality of affected organs). Without onset of cancer, the body mass reaches a constant balance depending on the caloric intake. Two treatments can be applied: specific inhibition on cancer growth by amplification of its secreted DNA and induction of sugar induced cell death (SICD) by administration of a glucose boost (see FIG. 19).

### Results

Based on the presented results, the conceptual model represented in FIG. 20 was defined. Extraction of circulating DNA secreted by the tumoral cells can be amplified and used as specific inhibitory product for the cancer proliferation with reduced effect on healthy cell. When the treatment is coupled with a glucose pulse it induces apoptosis in cancer cells, possibly leading to remission based on the specific type of cancer. The glucose treatment administered in the presented in vitro experiments on tumoral cells (Examples 11 and 12) can be translated to whole organisms through the administration of fine-tuned insulin treatments followed by a phleboclysis of glucose in physiological solution. Such intravenous drip of sugar, inducing a controlled and limited in time hyperglycaemic condition will be following the lowering of glucose content due to the pre-treatment by insulin. The treatment is conceived as a “starving” phase followed by a fast uptake of glucose from the bloodstream. Cancer cells with enhanced carriers for glucose transport can be expected to report higher fluctuations of glucose uptake compared to healthy cells with more controlled homeostasis in their metabolism. At the same time, due to the differential growth inhibition induced by the secreted DNA, cancer cells shall be more sensitive to Sugar Induced Cell Death as shown in the reported experiments. In order to enhance the effect and avoid possibly dangerous glycaemic levels in the patient, the insulin treatment has to be coupled with artificial glucose nutrition thus keeping glucose levels constant while inducing its enhanced uptake in the cancer cells.

To demonstrate this concept, a set of in silico experiments simulating the following scenarios was performed: 1) the appearance of a malignant cancer and its effect on the host based on the average caloric intake in the diet (FIG. 21); 2) effect of inhibition treatment with cancer secreted DNA on cancer progression and life expectancy (FIG. 22A,B); cancer remission following the combined treatment with cancer secreted DNA and glucose boost (FIG. 22C).

### REFERENCES

Blesa, A., and Berenguer, J. (2015). Contribution of vesicle-protected extracellular DNA to horizontal gene transfer in Thermus spp. Int. Microbiol. 18, 177-187. doi:10.2436/20.1501.01.248.
de Alteriis, E., Carteni, F., Parascandola, P., Serpa, J., and Mazzoleni, S. (2018). Revisiting the Crabtree/Warburg effect in a dynamic perspective: a fitness advantage against sugar-induced cell death. Cell Cycle 17, 688-701. doi:10.1080/15384101.2018.1442622.
Draghi, J. A., and Turner, P. E. (2006). DNA secretion and gene-level selection in bacteria. Microbiology 152, 2683-2688. doi:10.1099/mic.0.29013-0.
Granot, D., Levine, A., and Dor-Hefetz, E. (2003). Sugar-induced apoptosis in yeast cells. FEMS Yeast Res. 4, 7-13. doi:10.1016/S1567-1356(03)00154-5.
Kalluri, R., and LeBleu, V. S. (2016). Discovery of Double-Stranded Genomic DNA in Circulating Exosomes. Cold Spring Harb. Symp. Quant. Biol. 81, 275-280. doi:10.1101/sqb.2016.81.030932.
Lehmann, B. D., Paine, M. S., Brooks, A. M., McCubrey, J. A., Renegar, R. H., Wang, R., et al. (2008). Senescence-associated exosome release from human prostate cancer cells. Cancer Res. 68, 7864-7871. doi:10.1158/0008-5472.CAN-07-6538.
Mazzoleni S., Landi C., Carteni F., de Alteriis E., Giannino F, Paciello L. and Parascandola P. (2015). A novel process-based model of microbial growth: self-inhibition in Saccharomyces cerevisiae aerobic fed-batch cultures. Microb Cell Fact 14:109. DOI 10.1186/s12934-015-0295-4
Takahashi, A., Okada, R., Nagao, K., Kawamata, Y., Hanyu, A., Yoshimoto, S., et al. (2017). Exosomes maintain cellular homeostasis by excreting harmful DNA from cells. Nat. Commun. 8, 15287. doi:10.1038/ncomms15287.
Thierry, A. R., Messaoudi, S. El, Gahan, P. B., Anker, P., and Stroun, M. (2016). Origins, structures, and functions of circulating DNA in oncology. Cancer Metastasis Rev., 1-30. doi:10.1007/s10555-016-9629-x.
Segev E, Tellez A, Vlamakis H, Kolter R (2015) Morphological Heterogeneity and Attachment of Phaeobacter inhibens. PLOS ONE 10(11): e0141300. https://doi.org/10.1371/journal.pone.0141300
Monticolo, F., Palomba, E., Termolino, P., Chiaiese, P., de Alteriis, E., Mazzoleni, S., & Chiusano, M. L. (2020). The role of DNA in the extracellular environment: a focus on NETs, RETs and biofilms. Frontiers in Plant Science, 11, 2045
Barron C C, Bilan P J, Tsakiridis T, et al. Facilitative glucose transporters: Implications for cancer detection, prognosis and treatment. Vol. 65. Metabolism: Clinical and Experimental; 2016. p. 124-139.
DeBerardinis R J, Lum J J, Hatzivassiliou G, et al. The biology of cancer: metabolic reprogramming fuels cell growth and proliferation. Cell Metab. 2008; 7:11-20. doi:10.1016/j.cmet.2007.10.002.
de Ley et al. Eur J Biochem. 1970 January; 12(1):133-42 Sibley and Ahlquist, J Mol Evol (1984) 20:2-15

1. A non-therapeutic method for inhibiting a target species, said method comprising:
exposing said target species to DNA sequences secreted by cells of a source species or to a composition comprising said DNA sequences, wherein:
said source species is selected from a species that is the same species as the target species or a species phylogenetically similar to the target species,
with the proviso that said DNA sequences or composition do not comprise any DNA released by dead cells of the source species and do not comprise any secretome obtained by said cells of the source species.

2. The non-therapeutic method according to claim 1, wherein said DNA sequences secreted by cells of the source species are delivered by a carrier.

3. The non-therapeutic method according to claim 1, wherein said carrier is a host species differing from the source species, wherein the host is a microbial species, a multicellular organism, a helminth species, a soil microorganism, a GRAS status microorganism, or a microbial biocontrol agent.

4. The non-therapeutic method according to claim 1, wherein when the target species is a bacterium, said composition comprising the DNA sequences secreted by the cells of a source species further comprises a phage effective against said bacterium.

5. A method for therapeutic treatment of a disease or condition; the method comprising:
identifying an animal organism or a human organism in need of the therapeutic treatment;
delivering isolated DNA sequences or a composition comprising said isolated DNA sequences,
wherein said disease or condition is caused by a pathogenic, infesting or parasitic species or being a cancer disease,
wherein said isolated DNA sequences is an active ingredient inhibiting said pathogenic, infesting or parasitic species, the target species, or a cancer cell of said cancer disease, the target cell,
said isolated DNA sequences being DNA sequences secreted by:
cells of a source species selected from a species that is the same species as the target species or a species phylogenetically similar to the target species, when the disease or condition is caused by a pathogenic, infesting or parasitic species; or
a source cancer cell of the same cancer disease to be treated, said source cancer cell being selected from:
a target cell of the same animal organism or human organism to be treated, or
a cancer cell of an animal or human organism different from the animal or human organism to be treated;
with the proviso that said isolated DNA sequences or the composition does not comprise any DNA released by a dead cell of the source species or by a dead source cancer cell and do not comprise any secretome of the cell of the source species or of the source cancer cell.

6. The method according to claim 5, wherein said DNA sequences are delivered by a carrier.

7. The method according to claim 5, wherein said carrier that is a host species differing from the source species or from an animal or human cell is a microbial species, a multicellular plant, a helminth species, a soil microorganism, a GRAS status microorganism, or a microbial biocontrol agent.

8. The method according to claim 5, wherein the host species is Arthrospira platensis, when the isolated DNA sequences are secreted by a source cancer cell.

9. The method according to claim 5, said composition further comprising a second active ingredient for treating the disease or condition, such as wherein the second active ingredient is an anticancer active ingredient.

10. The method according to claim 5, wherein when the target species is a bacterium, the composition further comprises a phage effective against said bacterium.

11. A method for therapeutic treatment of a disease or condition, the method comprising:
identifying an animal or a human organism in need of the therapeutic treatment;
delivering a combination of isolated DNA sequences with one or more other active ingredients suitable for treating the disease or condition, said one or more other active ingredients being different from said isolated DNA sequences,
wherein said disease or condition is caused by a pathogenic, infesting or parasitic species or being a cancer disease,
wherein said isolated DNA sequences are the active ingredients inhibiting said pathogenic, infesting or parasitic species, the target species, or a cancer cell of said cancer disease, the target cell,
said isolated DNA sequences being DNA sequences secreted by:
cells of a source species selected from a species that is the same species as the target species or a species phylogenetically similar to the target species, when the disease or condition is caused by a pathogenic, infesting or parasitic species; or
a source cancer cell of the same cancer disease to be treated, said source cancel cell being selected from:
a target cell of the same animal organism or human organism to be treated, or
a cancer cell of an animal or human organism different from the animal or human organism to be treated,
with the proviso that said isolated DNA sequences do not comprise any DNA released by a dead cell (genomic DNA) of the source species or by a dead source cancer cell and do not comprise any secretome of the cell of the source species or of the source cancer cell.

12. The method of claim 11, wherein said isolated DNA sequences are delivered by a carrier.

13. The method according to claim 11, wherein said carrier that is a host species differing from the source species or from an animal or human cell is a microbial species, a species from the Ascomycota, a species from the Archaea, a microphyte, a multicellular organism, a helminth species, a soil microorganism, a GRAS status microorganism, or a microbial biocontrol agent.

14. The method according to claim 11, wherein the host species is Arthrospira platensis, when the DNA sequences are secreted by a source cancer cell.

15. The method according to claim 11, wherein said one or more other active ingredients are an anticancer active ingredient, glucose and/or insulin.

16. The method according to claim 11, wherein after or simultaneously delivering the secreted isolated DNA sequences, insulin and glucose are sequentially administered at least one time to induce at least one hypoglycemic peak followed by at least one hyperglycemic peak.

17. The method according to claim 11, wherein, when the target species is a bacterium, said one or more other active ingredients are a phage effective against said bacterium.

18. A composition for inhibiting a target species or for inhibiting a target cancer cell of an animal organism or human organism to be treated, said composition comprising:
isolated DNA sequences secreted by the cells of a source species or by a source cancer cell, wherein:
said source species is selected from a species that is the same species as the target species or a species phylogenetically similar to the target species,
said source cancer cell is selected from the target cell of the same animal organism or human organism to be treated, or a cancer cell of an animal or human organism different from the animal or human organism to be treated, and
said isolated DNA sequences are delivered by a carrier,
with the proviso that said isolated DNA sequences or the composition does not comprise any DNA released by a dead cell of the source species or by a dead source cancer cell and do not comprise any secretome of the cell of the source species or of the source cancer cell.

19. The composition according to claim 18,
wherein said carrier is a host species differing from the source species, wherein the carrier species is a species is a microbial species, a species of Ascomycota, a species the of Archaea, a microphyte, a multicellular organism, a helminth species, a soil microorganism, a GRAS status microorganism, or a microbial biocontrol agent.

20. The composition according to claim 18, wherein, when the target species is a bacterium, said composition further comprises a phage effective against said bacterium.

21. A composition for inhibiting a bacterium, wherein the bacterium is a target species, said composition comprising DNA sequences secreted by cells of a source species and a phage effective against said bacterium, wherein said source species is selected from the same bacterium as the target species or a bacterium phylogenetically similar to the target species.
